(19) United States
(12) Patent Application Publication
(10) Pub. No.: US 2019/0040980 A1
(43) Pub. Date: Feb. 7, 2019

(54) COMPONENT RETAINING STRUCTURE FOR CONDUIT FITTING

(71) Applicant: Swagelok Company, Solon, OH (US)

(72) Inventors: Mark D. Bearer, Akron, OH (US); Cal R. Brown, Lyndhurst, OH (US); Ronald P. Campbell, Shaker Heights, OH (US); Gregory S. Kalata, Avon, OH (US); Douglas J. McClure, Mentor, OH (US); Douglas S. Welch, Chesterland, OH (US); Peter C. Williams, Cleveland Heights, OH (US); Stephen J. Zaborszki, Northfield, OH (US)

(21) Appl. No.: 16/053,900

(22) Filed: Aug. 3, 2018

Related U.S. Application Data
(60) Provisional application No. 62/540,635, filed on Aug. 3, 2017.

(51) Int. Cl. F16L 19/02; F16L 13/14; F16L 19/07; F16L 19/10

(52) U.S. Cl. CPC F16L 19/0218; F16L 13/146; F16L 19/14; F16L 19/103; F16L 19/07

(57) ABSTRACT

A preassembly for a conduit fitting includes an annular fitting component and at least a first conduit gripping device. The annular fitting component has an interior wall including an inboard surface having a first diameter, an outboard surface having a second diameter, and an intermediate surface recessed from the inboard surface by an outward facing inboard radial wall and recessed from the outboard surface by an inward facing outboard radial wall. The first conduit gripping device is retained within the annular fitting component and includes a body portion and an annular ring portion having an inner radial portion secured to a rear surface of the body portion, and a flange portion extending radially outward of the inner radial portion to define a projection extending radially outward of an outer circumferential surface of the first conduit gripping device, with an end portion of the projection being axially captured between the inboard radial wall and the outboard radial wall.

### CROSS-REFERENCE TO RELATED APPLICATION

This application claims priority to and all benefit of U.S. Provisional Patent Application Ser. No. 62/540,635, filed on Aug. 3, 2017, for COMPONENT RETAINING STRUCTURE FOR CONDUIT FITTING, the entire disclosure of which is fully incorporated herein by reference.

### TECHNICAL FIELD OF THE INVENTIONS

The present disclosure relates to fittings for making mechanically attached connections between a conduit and another fluid component, for containing liquid or gas fluids. More particularly, the disclosure relates to fittings for tube and pipe conduits that use one or more conduit gripping devices, such as for example, one or more ferrules.

### SUMMARY OF THE DISCLOSURE

In accordance with an embodiment of one or more of the inventions presented in this disclosure, a preassembly for a conduit fitting includes an annular fitting component and at least a first conduit gripping device. The annular fitting component has an interior wall extending along a central axis from an inboard end to an outboard end, the interior wall including an inboard surface having a first diameter, an outboard surface having a second diameter, and an intermediate surface recessed from the inboard surface by an outward facing inboard radial wall and recessed from the outboard surface by an inward facing outboard radial wall. The first conduit gripping device is retained within the annular fitting component and includes a body portion and an annular ring portion having an inner radial portion secured to a rear surface of the body portion, and a flange portion extending radially outward of the inner radial portion to define a projection extending radially outward of an outer circumferential surface of the first conduit gripping device, with an end portion of the projection being axially captured between the inboard radial wall and the outboard radial wall.

In accordance with another embodiment of one or more of the inventions presented in this disclosure, a ferrule includes a body portion defining a tapered outer surface, a cylindrical interior wall, and a rear radial surface, and an annular ring portion having an inner radial portion secured to the rear radial surface of the body portion, and a flange portion extending radially outward of the inner radial portion to define a projection extending radially outward of the outer surface of the body portion.

In accordance with another embodiment of one or more of the inventions presented in this disclosure, a method of assembling an annular fitting component with at least a first conduit gripping device is contemplated. In an exemplary method, the first conduit gripping device is inserted into an inboard end of the annular fitting component, such that a projection extending axially forward toward a front end of the first conduit gripping device and radially outward of an outer circumferential surface of the first conduit gripping device to a first diameter is received through an inboard surface of an interior wall of the annular fitting component along a central axis, and axially aligns with an annular recess of the interior wall. A tool is inserted into the inboard end of the annular fitting component to apply an outward axial force against the projection, such that the projection is bent axially and radially outward to position an end portion of the projection within the annular recess, to axially capture the projection between the inboard radial wall and the outboard radial wall.

In accordance with another embodiment of one or more of the inventions presented in this disclosure, a fitting assembly includes annular first and second fitting components and at least a first conduit gripping device retained within the first fitting component. The annular first fitting component has an interior wall defining an annular recess disposed between an outward facing inboard radial wall and an inward facing outboard radial wall. The annular second fitting component assembled with the first fitting component to define an interior volume surrounded by the interior wall of the first fitting component. The first conduit gripping device includes a projection extending radially outward from a hinge portion disposed on an outer surface of the first conduit gripping device, to an end portion axially captured in the annular recess. When the fitting is pulled up on a conduit end, the end portion of the projection engages the outboard radial wall and the projection bends axially and radially inward and the projection separates from the first conduit gripping device at the hinge portion, the separated projection being received in an outer circumferential recess of the first conduit gripping device, such that the separated projection is retained with the first conduit gripping device, and the first conduit gripping device is removable from the first fitting component when the first fitting component is disassembled from the second fitting component.

In accordance with another embodiment of one or more of the inventions presented in this disclosure, a preassembly for a conduit fitting includes an annular fitting component and at least a first conduit gripping device. The annular fitting component has an interior wall extending along a central axis from an inboard end to an outboard end, the interior wall including an inboard surface having a first diameter, an outboard surface having a second diameter, and an intermediate surface recessed from the inboard surface by an outward facing inboard radial wall and recessed from the outboard surface by an inward facing outboard radial wall. The first conduit gripping device is retained within the annular fitting component and including a body portion and an annular ring portion extending radially outward of an outer circumferential surface of the first conduit gripping device to define a projection, with an end portion of the projection being axially captured between the inboard radial wall and the outboard radial wall. The body portion has a first material property and the annular ring portion has a second material property different from the first material property, the second material property being selected to facilitate radially and axially inward bending movement of the projection against the outboard radial wall when the preassembly is pulled up on a mating fitting component.

In accordance with another embodiment of one or more of the inventions presented in this disclosure, a ferrule includes a body portion defining a tapered outer surface, a cylindrical interior wall, and a rear radial surface, and an annular ring portion extending radially outward of an outer circumferential surface of the body portion to define a projection. The body portion has a first material property and the annular ring portion has a second material property different from the first material property, the second material property being selected to facilitate radially and axially inward bending movement of the projection.

These and other aspects and advantages of the inventions described herein will be readily appreciated and understood by those skilled in the art in view of the accompanying drawings.

### BRIEF DESCRIPTION OF THE DRAWINGS

Further features and advantages of the inventions will become apparent from the following detailed description made with reference to the accompanying drawings, which are not necessarily (but may be) drawn to scale, wherein:

FIG. 1 is a longitudinal cross-sectional view of an exemplary fitting nut and ferrules, shown with the ferrules loosely inserted in the fitting nut;

FIG. 1A is an enlarged view of the circled region of FIG. 1;

FIG. 2 is a longitudinal cross-sectional view of the fitting nut and ferrules of FIG. 1, shown assembled as a cartridged preassembly;

FIG. 2A is an enlarged view of the circled region of FIG. 2;

FIG. 3 is a longitudinal cross-sectional view of a conduit fitting assembly using the subassembly of FIG. 1, shown in a pulled-up condition;

FIG. 3A is an enlarged view of the circled region of FIG. 3;

FIG. 4 is a longitudinal cross-sectional view of an exemplary fitting nut and ferrules, shown with the ferrules loosely inserted in the fitting nut;

FIG. 4A is an enlarged view of the circled region of FIG. 4;

FIG. 5 is a longitudinal cross-sectional view of the fitting nut and ferrules of FIG. 4, shown assembled as a cartridged preassembly;

FIG. 5A is an enlarged view of the circled region of FIG. 5;

FIG. 6 is a longitudinal cross-sectional view of a conduit fitting assembly using the subassembly of FIG. 4, shown in a pulled-up condition;

FIG. 6A is an enlarged view of the circled region of FIG. 6;

FIG. 7 is a longitudinal cross-sectional view of an exemplary fitting nut and ferrules, shown with the ferrules loosely inserted in the fitting nut;

FIG. 7A is an enlarged view of the circled region of FIG. 7;

FIG. 8 is a longitudinal cross-sectional view of the fitting nut and ferrules of FIG. 7, shown assembled as a cartridged preassembly;

FIG. 8A is an enlarged view of the circled region of FIG. 8;

FIG. 9 is a longitudinal cross-sectional view of a conduit fitting assembly using the subassembly of FIG. 7, shown in a pulled-up condition;

FIG. 9A is an enlarged view of the circled region of FIG. 9;

FIG. 10 is a longitudinal cross-sectional view of an exemplary fitting nut and ferrules, shown with the ferrules loosely inserted in the fitting nut;

FIG. 10A is an enlarged view of the circled region of FIG. 10;

FIG. 11 is a longitudinal cross-sectional view of the fitting nut and ferrules of FIG. 10, shown assembled as a cartridged preassembly;

FIG. 11A is an enlarged view of the circled region of FIG. 11;

FIG. 12 is a longitudinal cross-sectional view of a conduit fitting assembly using the subassembly of FIG. 10, shown in a pulled-up condition;

FIG. 12A is an enlarged view of the circled region of FIG. 12;

FIG. 13 is a longitudinal cross-sectional view of an exemplary fitting nut and ferrules, shown with the ferrules loosely inserted in the fitting nut;

FIG. 13A is an enlarged view of the circled region of FIG. 13;

FIG. 14 is a longitudinal cross-sectional view of the fitting nut and ferrules of FIG. 13, shown assembled as a cartridged preassembly;

FIG. 14A is an enlarged view of the circled region of FIG. 14;

FIG. 15 is a longitudinal cross-sectional view of a conduit fitting assembly using the subassembly of FIG. 13, shown in a pulled-up condition;

FIG. 15A is an enlarged view of the circled region of FIG. 15;

FIG. 15B is an enlarged view of the circled region of FIG. 15, modified to show the bent projection in a fractured, retained condition;

FIG. 16 is a longitudinal cross-sectional view of an exemplary fitting nut and ferrules, shown with the ferrules loosely inserted in the fitting nut;

FIG. 16A is an enlarged view of the circled region of FIG. 16;

FIG. 17 is a longitudinal cross-sectional view of the fitting nut and ferrules of FIG. 16, shown assembled as a cartridged preassembly;

FIG. 17A is an enlarged view of the circled region of FIG. 17;

FIG. 18 is a longitudinal cross-sectional view of a conduit fitting assembly using the subassembly of FIG. 16, shown in a pulled-up condition;

FIG. 18A is an enlarged view of the circled region of FIG. 18;

FIG. 18B is an enlarged view of the circled region of FIG. 18, modified to show the bent projection in a fractured, retained condition;

FIG. 19 is a longitudinal cross-sectional view of an exemplary fitting nut and ferrules, shown with the ferrules loosely inserted in the fitting nut;

FIG. 19A is an enlarged view of the circled region of FIG. 19;

FIG. 20 is a longitudinal cross-sectional view of the fitting nut and ferrules of FIG. 19, shown assembled as a cartridged preassembly;

FIG. 20A is an enlarged view of the circled region of FIG. 20;

FIG. 21 is a longitudinal cross-sectional view of a conduit fitting assembly using the subassembly of FIG. 19, shown in a pulled-up condition;

FIG. 21A is an enlarged view of the circled region of FIG. 21;

FIG. 22 is a longitudinal cross-sectional view of an exemplary fitting nut and ferrules, shown with the ferrules loosely inserted in the fitting nut;

FIG. 22A is an enlarged view of the circled region of FIG. 22;

FIG. 23 is a longitudinal cross-sectional view of the fitting nut and ferrules of FIG. 22, shown with the ferrule projection bent radially outward for cartridging engagement with the nut recess;

FIG. 23A is an enlarged view of the circled region of FIG. 23;

FIG. 24 is a longitudinal cross-sectional view of a conduit fitting assembly using the subassembly of FIG. 22, shown in a pulled-up condition;

FIG. 24A is an enlarged view of the circled region of FIG. 24;

FIG. 25 is a longitudinal cross-sectional view of an exemplary fitting nut and ferrules, shown with the ferrules loosely inserted in the fitting nut;

FIG. 25A is an enlarged view of the circled region of FIG. 25;

FIG. 26 is a longitudinal cross-sectional view of the fitting nut and ferrules of FIG. 25, shown with the ferrule projection bent forward for alignment with the nut recess;

FIG. 26A is an enlarged view of the circled region of FIG. 26;

FIG. 27 is a longitudinal cross-sectional view of an exemplary ferrule including a cartridging flange ring attached to a rear portion of the ferrule;

FIG. 27A is an enlarged view of the circled region of FIG. 27, showing a spot welded cartridging flange ring;

FIG. 27B is an enlarged view of the circled region of FIG. 27, showing a perforated cartridging flange ring;

FIG. 27C is an enlarged view of the circled region of FIG. 27, showing a separate cartridging flange ring prior to a staking assembly operation;

FIG. 27D is an enlarged view of the circled region of FIG. 27, showing a separate cartridging flange ring following a staking assembly operation;

FIG. 28 is a longitudinal cross-sectional view of an exemplary ferrule including a separate cartridging flange ring;

FIG. 28A is an enlarged view of the circled region of FIG. 28, showing a spot welded cartridging flange ring;

FIG. 28B is an enlarged view of the circled region of FIG. 28, showing a perforated cartridging flange ring;

FIG. 28C is an enlarged view of the circled region of FIG. 28, showing a separate cartridging flange ring prior to a staking assembly operation; and

FIG. 28D is an enlarged view of the circled region of FIG. 28, showing a separate cartridging flange ring following a staking assembly operation.

### DESCRIPTION OF THE EXEMPLARY EMBODIMENTS

Although the exemplary embodiments herein are presented in the context of a stainless steel tube fitting, the inventions herein are not limited to such applications, and will find use with many different conduits such as tube and pipe as well as different materials other than 316 stainless steel, including metals and non-metals for either the conduit, the gripping devices or the fitting components or any combination thereof. The inventions may also be used for liquid or gas fluid systems. While the inventions herein are illustrated with respect to particular designs of the conduit gripping devices and fitting components, the inventions are not limited to use with such designs, and will find application in many different fitting designs that use one or more conduit gripping devices. We use the term “conventional” to refer to commercially available or later developed parts or parts that are otherwise commonly known, used or that those of ordinary skill in the art would be familiar with in general, as distinguished from parts that may be modified in accordance with teachings herein. We use the term “ferrule set” to refer to a combination of conduit gripping devices with or without other parts that form the means by which conduit grip and seal are achieved. Although not necessary with all fitting designs, it is common that a ferrule set comprises two ferrules that are purposely matched to each other and to the fitting components, for example, based on material, manufacturer, interrelated design and geometry features and so on. In some fittings, in addition to the conduit gripping devices there may be one or more additional parts, for example seals. Therefore, the term “ferrule set” may also include in some embodiments the combination of one or more conduit gripping devices with one or more other parts by which the ferrule set effects conduit grip and seal after a complete pull-up. The inventions may be used with tube or pipe, so we use the term “conduit” to include tube or pipe or both. We generally use the term “fitting assembly” or “fitting” interchangeably as a shorthand reference to an assembly of typically first and second fitting components along with one or more conduit gripping devices. The concept of a “fitting assembly” thus may include assembly of the parts onto a conduit, either in a finger-tight position, a partial pull-up position or complete pull-up position; but the term “fitting assembly” is also intended to include an assembly of parts together without a conduit, for example for shipping or handling, as well as the constituent parts themselves even if not assembled together.

The term “complete pull-up” and derivative forms as used herein refers to joining the fitting components together so as to cause the one or more conduit gripping devices to deform, usually but not necessarily plastically deform, to create a fluid tight seal and grip of the fitting assembly on the conduit. A “partial pull-up” and derivative terms as used herein refers to a partial but sufficient tightening of the male and female fitting components together so as to cause the conduit gripping device or devices to deform so as to be radially compressed against and thus attached to the conduit, but not necessarily having created a fluid tight connection or the required conduit grip that is achieved after a complete pull-up. The term “partial pull-up” thus may also be understood to include what is often referred to in the art as pre-swaging wherein a swaging tool is used to deform the ferrules onto the conduit sufficiently so that the ferrules and the nut are retained on the conduit prior to being mated with the second fitting component to form a complete fitting assembly. A finger tight position or condition refers to the fitting components and conduit gripping devices being loosely assembled onto the conduit but without any significant tightening of the male and female fitting components together, usually typified by the conduit gripping device or devices not undergoing plastic deformation.

Fittings typically include two fitting components that are joined together, and one or more gripping devices, however, the inventions herein may be used with fittings that include additional pieces and parts. For example, a union fitting may include a body and two nuts. We also use the term “fitting remake” and derivative terms herein to refer to a fitting assembly that has been at least once tightened or completely pulled-up, loosened, and then re-tightened to another completely pulled-up position. Remakes may be done with the same fitting assembly parts (e.g. nut, body, ferrules), for example, or may involve the replacement of one of more of the parts of the fitting assembly. Reference herein to “outboard,” “axially outward,” “inboard,” and “axially inward” are for convenience and simply refer to whether a direction is towards the center of a fitting (inboard or axially inward) or away from the center (outboard or axially outward). In the drawings, various gaps and spaces between parts (for example, gaps between the ferrules and the conduit in a finger-tight position) may be somewhat exaggerated for clarity or due to scale of the drawings.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include both the specified value and values within 10% of the specified value, unless expressly stated otherwise. Further, it is to be understood that the drawings accompanying the present application may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

A significant feature of some of the inventions herein is the provision of a retaining structure by which one or more conduit gripping devices are retained with a fitting component, also referred to herein as a retaining fitting component, prior to assembly of the fitting component with a mating fitting component. By “cartridge” we mean a group of parts retained together as a discontinuous unit, subassembly or preassembly. We therefore use the terms cartridge, unit, subassembly and preassembly synonymously herein in the context of a discontinuous structure. We also use the term “cartridge nut” or “conduit fitting cartridge” herein to refer to such a cartridge, unit or subassembly in which one or more conduit gripping devices are retained with a fitting component such as a female nut, for example. We also use the term “ferrule cartridge” or “conduit gripping device cartridge” to refer to a unit or subassembly made up of at least one ferrule or conduit gripping device with at least one other part held together as a discrete unit. In particular, a “ferrule cartridge” includes two or more ferrules held together as a discrete unit or subassembly, and may include additional parts, for example, seals. In the exemplary embodiments herein, the cartridge includes one or more ferrules retained with a fitting component, such as a female threaded nut. Therefore, the exemplary embodiments herein may be referred to as a cartridge nut design, however in alternative embodiments, a “cartridge nut” may include a male threaded cartridge nut design or a cartridge body design.

We use the term “discontinuous” to describe the conjoined nature of the cartridge or preassembly in the sense that the one or more conduit gripping devices and the retaining fitting component, for example a female threaded nut in illustrated embodiments described herein, are manufactured as separate and discrete components and remain separate and discrete components, although in accordance with the inventions herein these components may be retained together as a discrete cartridge, subassembly or preassembly, and further wherein after final assembly or even a complete pull-up the parts remain discrete and may be disassembled into their constituent discrete parts if so desired. The terms “discontinuous” or “conjoined” are used herein to distinguish from fitting designs in which a conduit gripping device is attached to or made integral with a fitting component, wherein the conduit gripping device may remain integral or may in some designs break off or detach from the fitting component during complete or partial pull-up. In a discontinuous type structure, as that terminology is used in this disclosure, the one or more conduit gripping devices may optionally release or become separable from the retaining fitting component during either partial or complete pull-up without requiring a fracture, shear or other separation of the retaining fitting component material or adhesive to separate from the conduit gripping device. The terms “discontinuous” or “conjoined” are further intended to include broadly the idea that the one or more conduit gripping devices may be loosely or alternatively snugly retained with the retaining fitting component.

As one aspect of the present application, use of a discontinuous fitting component cartridge may facilitate providing ferrule sets to the end user in which the ferrules and nuts are properly oriented, matched, and assembled at the manufacturer. This can significantly simplify inventory control and reduce final assembly time. The embodiments herein also allow for a cartridge design in which the retaining fitting component may be used for fitting assemblies that do not need or have the retaining member. In other words, the cartridge designs herein use a nut or retaining fitting component that is backwards compatible with fitting assemblies that the end user may not require with a retaining structure. The cartridge design also may be realized using ferrule sets that do not require modification. Therefore, the cartridge concepts herein may be optionally provided for an end user without having to manufacture nuts or ferrules with different geometry and operation or performance. This allows the convenience of manufacturing and selling fitting components and ferrules as separate parts regardless of the end use of such individual parts, either for a cartridge use or a non-cartridge use.

As another aspect of the present application, a cartridge design with a female fitting component may include a ferrule or ferrules that are retained within the machined socket of the female fitting component (e.g., female nut), with the inboard fitting component end extending preferably but not necessarily axially past the front end of the front ferrule. The ferrule or ferrules thus are somewhat shrouded and protected from possible damaging impacts against the ferrule surfaces.

In many applications, it may be desirable after a partial or complete pull-up to be able to remove the retaining fitting component without disturbing the one or more conduit gripping devices. For example, after a fitting assembly has been completely pulled up onto a conduit, the conduit gripping devices typically although not necessarily have been plastically deformed into a gripping engagement against the conduit outer surface. It is not uncommon for assembled fittings to be later disassembled in order to allow maintenance and repair of one or more fluid components in a fluid system. After the repair or maintenance is completed the fitting is reassembled and retightened. This process is commonly referred to in the art as disassembly and remake. But in order to perform many repair and maintenance activities, the nut often must be removed, or at least be slid axially back or away from the body in order to allow the conduit to be withdrawn from the body. Typically, it will be desired to leave the one or more conduit gripping devices attached to the conduit, and even if that is not a desired outcome, it may often be desired to allow the nut to be pulled axially back away from the ferrules, which may not be possible unless the nut and ferrules have become released or separable from each other during pull-up. Therefore, it may be a desirable option that in such cases the nut and conduit gripping devices are or become separable upon a partial or complete pull-up, at least to the extent that the ferrules and the retaining structure do not interfere with backing the retaining fitting component away from the mating fitting component and conduit gripping devices.

Exemplary cartridge nut arrangements are described in co-owned U.S. Pat. No. 8,931,810, titled CONDUIT GRIPPING DEVICE HAVING RETAINING STRUCTURE FOR CONDUIT FITTING (the “'810 Patent”), U.S. patent application Ser. No. 15/248,288, filed on Aug. 26, 2016 and titled COMPONENT RETAINING STRUCTURE FOR CONDUIT FITTING (the “'288 Application”), U.S. patent application Ser. No. 15/416,048, filed on Jan. 26, 2017 and titled COMPONENT RETAINING STRUCTURE FOR CONDUIT FITTING (the “'048 Application”), and U.S. patent application Ser. No. 15/441,694, filed on Feb. 24, 2017 and titled COMPONENT RETAINING STRUCTURE FOR CONDUIT FITTING (the “'694 Application”), the entire disclosures of each of which are incorporated herein by reference.

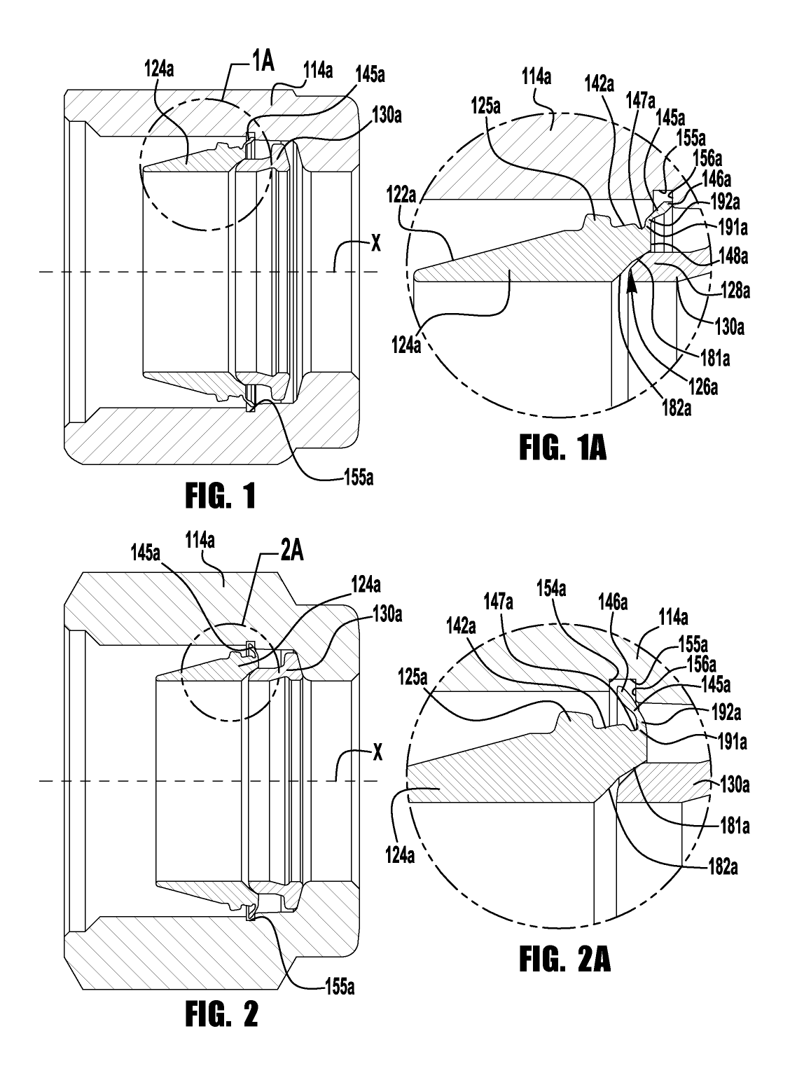

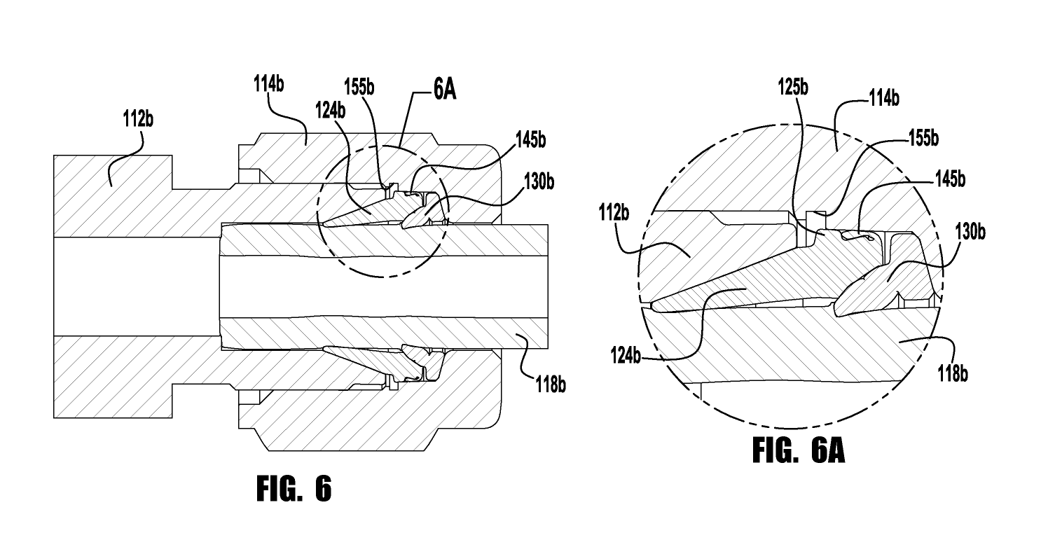

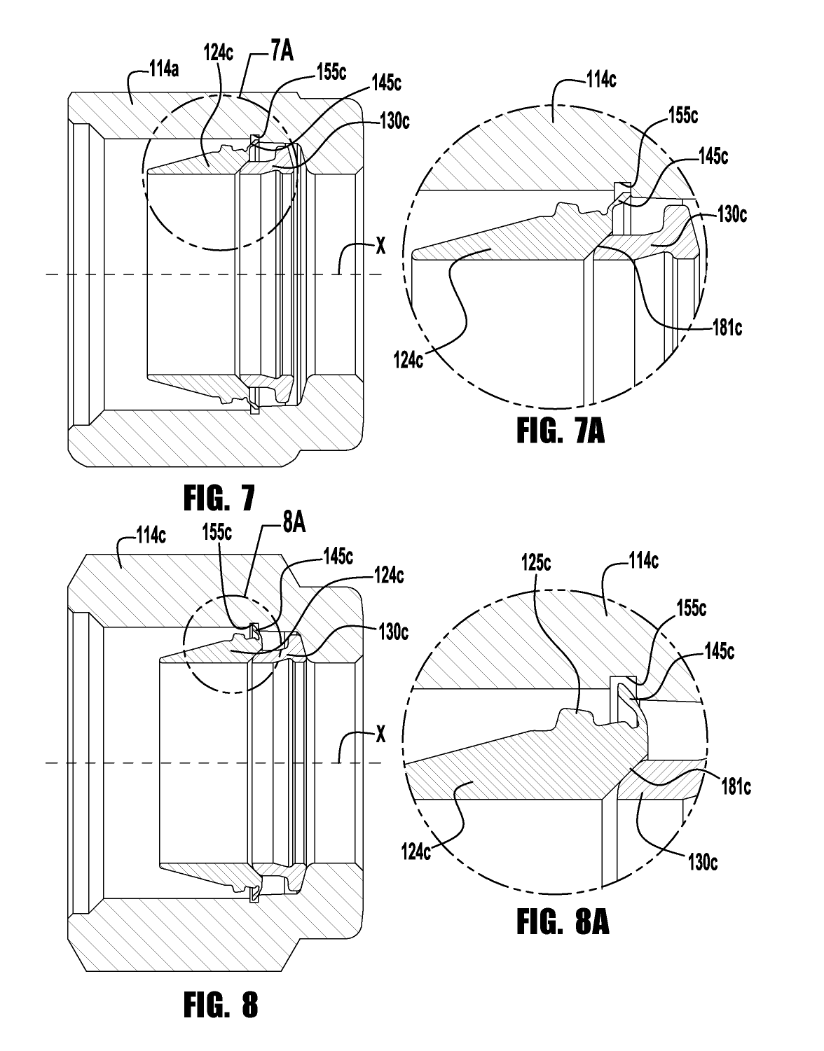

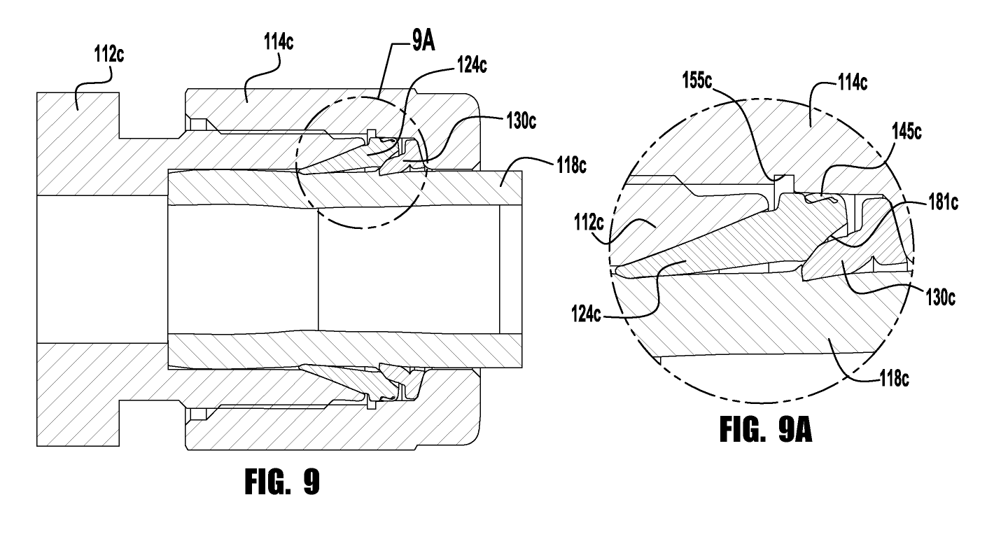

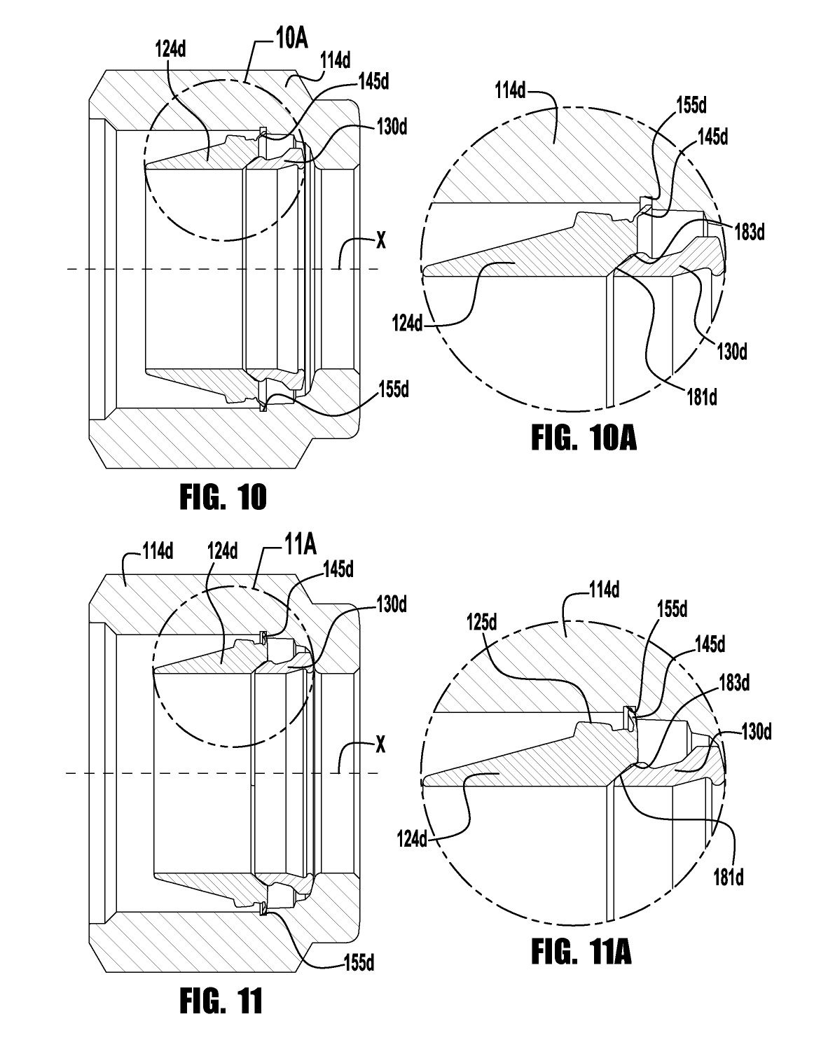

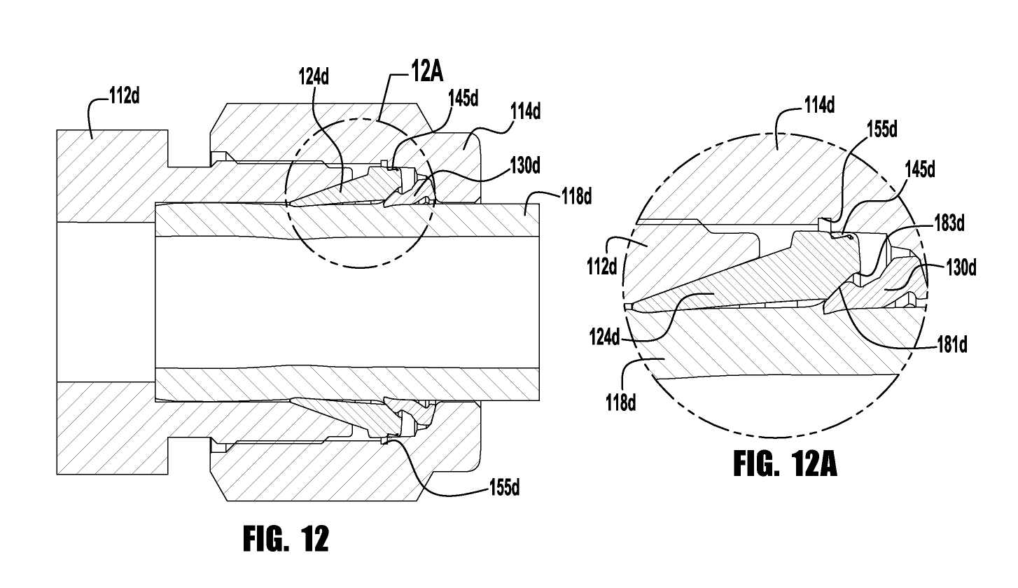

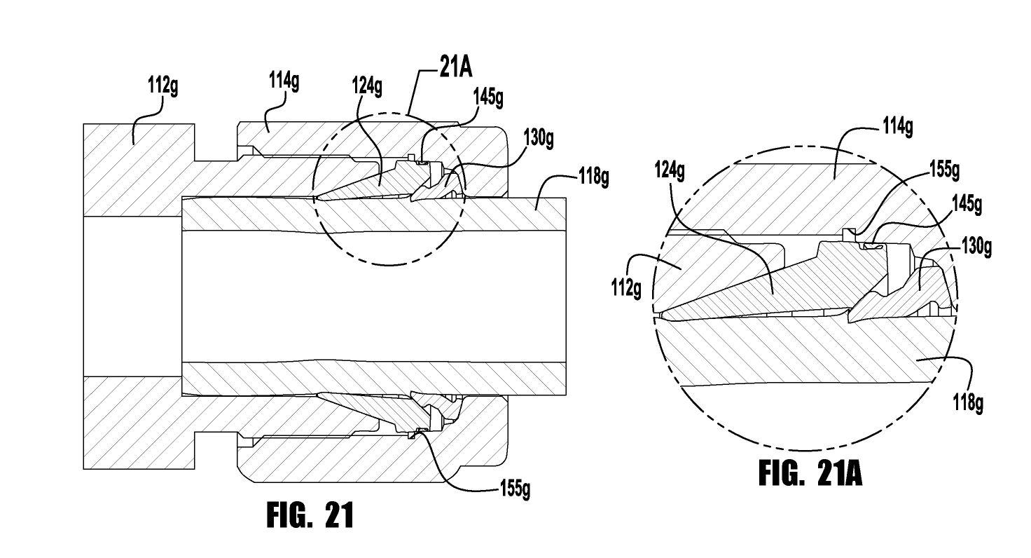

In some embodiments of the '810 Patent and the '288 Application (see, e.g., the embodiments of FIGS. 23-42 of the '810 Patent and the embodiments of FIGS. 1A-6B of the '288 Application), a component retaining or cartridging structure includes a separate retaining ring that is movable within a retaining fitting component (e.g., fitting nut) between a first position that retains or captures a portion of the conduit gripping device within the retaining fitting component, and a second position radially spaced apart from the portion of the conduit gripping device to permit withdrawal or removal of the conduit gripping device from the retaining fitting component. In other embodiments of the '810 Patent, the '288 Application, and the '048 Application (see, e.g., the embodiments of FIGS. 1-22 of the '810 Patent, the embodiments of FIGS. 7-17 of the '288 Application, and the embodiments of FIGS. 1-6 of the '048 Application), a radially outer portion of the conduit gripping device or ferrule engages a radially inner portion of the retaining fitting component or nut during installation or cartridging, with either or both of the radially outer ferrule portion and the radially inner nut portion elastically deforming to allow the radially outer ferrule portion to move axially outward of the radially inner nut portion, and then snap back into radial alignment to retain the radially outer ferrule portion between the radially inner nut portion and an outboard annular shoulder of the nut.

In still other embodiments of the '048 Application (see, e.g., the embodiments of FIGS. 7-49), a retaining projection on a conduit gripping device initially (i.e., prior to cartridging) extends in an outboard or axially outward angled orientation such that the projection is loosely received in axial alignment with a retaining recess in a retaining fitting component (e.g., fitting nut), without elastic deformation and snap-in engagement of the projection with the recess. To cartridge the conduit gripping device with the retaining fitting component, the retaining fitting component includes an inward facing, outboard radial wall that defines an outer end of the recess and extends radially inward into alignment with the end portion of the projection. When an axial outward force is applied to the conduit gripping device to engage the projection end portion with the outboard radial wall, the projection is bent or pivoted axially forward and radially outward to a position in which the projection end portion radially aligns with an inboard radial wall defining an inner end of the recess, such that the outward bent projection is axially captured in the recess between the inboard radial wall and the outboard radial wall. By deforming the projection radially outward during cartridging, the retaining fitting component and conduit gripping device assembly does not rely on elastic or snap-back deformation of the projection as the projection is installed in the recess. As such, the radially outwardly deformed projection may provide more rigid interlocking engagement with the nut recess, and greater radial overlap with the inboard radial wall. Additionally, the use of a pre-cartridged ferrule having a shallow angled cartridging projection may allow for machining of the ferrule from a smaller barstock, as compared to a pre-cartridged ferrule having a substantially laterally extending projection, while still providing for a cartridged ferrule having a radially outwardly deformed projection with substantial radial overlap with a cartridging recess.

FIGS. 1-21 of the present application illustrate other exemplary embodiments of conduit gripping devices (front ferrule 124a-g) with retaining projections 145a-g that initially (i.e., prior to cartridging) extend in an outboard or axially outward angled orientation such that the projection is loosely received in axial alignment with a retaining recess 155a-g in a retaining fitting component (fitting nut 114a-g). To cartridge the conduit gripping device with the retaining fitting component, the retaining fitting component includes an inward facing, outboard radial wall that defines an outer end of the recess and extends radially inward into alignment with the end portion of the projection. When an axial outward force is applied to the conduit gripping device 124a-g to engage the projection end portion 146a-g with the outboard radial wall 156a-g, the projection is bent or pivoted axially forward and radially outward to a position in which the projection end portion radially aligns with an inboard radial wall 154a-g defining an inner end of the recess 155a-g, such that the outward bent projection is axially captured in the recess between the inboard radial wall and the outboard radial wall.

FIGS. 1-3 illustrate an exemplary embodiment of a retaining nut 114a and a cartridging front ferrule 124a including features that improve or control hinging deformation, load distribution, and/or relief contouring of an annular ring portion or other cartridging projection 145a during cartridging and/or during fitting pull-up (e.g., release of the cartridged ferrule, discussed in greater detail below and in the above incorporated '810 Patent, '288 Application, '048 Application, and '694 Application). Any one or more of these features may be incorporated into any of the other exemplary embodiments described herein.

A cartridging projection of a ferrule may be provided with multiple hinge portions or hinge points, for example, to accelerate hinging deformation during cartridging and/or release, and the resulting radial expansion (during cartridging) and/or contraction (during pull-up) of the projection, and/or to reduce the deformation and associated stresses at a single hinge point. In the illustrated embodiment of FIGS. 1-3, the annular cartridging projection 145a includes a first hinge portion 191a at a base of the projection, and a second hinge portion 192a radially outward of, and adjacent to, the first hinge portion. To provide for separate and/or sequential hinging action at the first and second hinging portions, the first hinge portion 191a has a first thickness to length ratio (e.g., a ratio of about 0.7 to 0.9), and the second hinge portion 192a has a second thickness to length ratio (e.g., a ratio of about 0.35 to 0.75) smaller than the first thickness to length ratio, such that an initial axial load applied to the end portion 146a of the projection 145a during cartridging and/or pull-up causes the projection to bend primarily at the second hinge portion 192a for radial expansion (during cartridging) and/or radial contraction (during fitting pull-up). During further pull-up of the fitting (and the resulting axial load applied to the end portion 146a of the projection 145a), increased bending of the first hinge portion 191a occurs, causing the projection to fold into the outer circumferential recess 142a between the first hinge portion and the outer radial flange or boss 125a of the ferrule 124a.

FIGS. 1 and 1A show the nut 114a and ferrules 124a, 130a in an initial pre-cartridged condition. In the exemplary embodiment, the first hinge portion 191a extends radially outward (e.g., about 90° with respect to the central axis X), with an outboard surface substantially flush with an outboard radial surface 148a of the ferrule 124a. In the illustrated embodiments, the first hinge portion 191a has a thickness that narrows or tapers smaller (e.g., at about 5° to about 10°) from a radially inner end to a radially outer end, and as shown, may include a fillet radius at the base of the inboard surface of the first hinge portion, for example, to provide increased rigidity, and/or to provide all or part of the tapering of the first hinge portion. The second hinge portion 192a of the exemplary embodiment extends radially outward and axially outboard between the first hinge portion and an enlarged load bearing end portion 146a of the projection 145a.

In the illustrated embodiment of FIGS. 1-3, the second hinge portion 192a has an outboard radius portion extending between a radial outboard wall of the first hinge portion 191a and an enlarged outboard surface of the end portion 146a to provide a short, narrow second hinge portion. This shortened hinge portion may provide for an increased change in the radial dimension of the projection during bending (i.e., radial expansion during cartridging, radial contraction during pull-up), with the radiused, narrowed second hinge portion also providing for reduced stress at the second hinge portion during bending. The circumferential recess 142a and outer radial boss 125a may be sized to correspond with this shorter projection 145a.

FIGS. 2 and 2A show the nut 114a and ferrules 124a, 130a in a cartridged condition, for example, as a result of an outboard axial load applied to the front ferrule 124a (e.g., applied to an inboard surface of the ferrule boss portion 125a by an insertable tool, as described and shown in the above incorporated '048 Application), causing the projection 145a to engage and be deformed radially outward by the outboard radial wall 156a of the nut recess 155a. As shown, the second hinge portion 192a is bent to an axially inward direction (e.g., to an angle between about 90° and about 50°, or about 55°, with respect to the central axis X) to cause the projection end portion 146a to extend radially into the nut recess between the inboard and outboard radial walls 154a, 156a, thereby axially retaining the front ferrule 124a (and with it, the captured rear ferrule 130a) with the nut 114a. The first hinge portion 191a is slightly bent to an axially inward direction (e.g., to an angle between about 90° and about 70°, or about 80°, with respect to the central axis X).

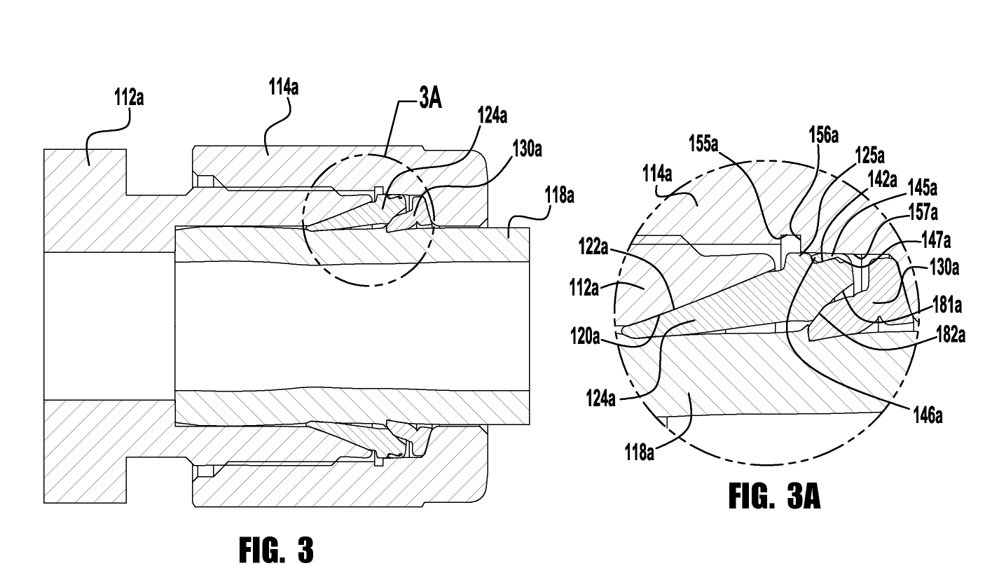

The outboard radial wall and outboard surface of the nut interior wall may be configured to bend or pivot the projection axially and radially inward from the laterally outward cartridged condition during complete or partial pull-up of the fitting on a conduit end, such that the end portion of the projection is positioned radially inward of the inboard surface of the nut interior wall, to allow withdrawal of the ferrules from the nut when the nut is disassembled from the body. FIGS. 3 and 3A show the nut 114a and ferrules 124a, 130a pulled up with a fitting body 112a on a conduit end 118a, with the front ferrule projection 145a bent into a fully axially inboard direction (e.g., with the second hinge portion and projection end portion extending to an angle between about 10° and about −10°, or about −5°, with respect to the central axis X), such that the projection is fully disengaged from the nut recess 155a and received in the outer circumferential recess 142a in the front ferrule 124a, and above, flush with, or even recessed from the outer surface of the ferrule boss 125a. As shown, the first hinge portion 191a is folded in an axially inboard direction (e.g., to an angle between about 60° and about 40°, or about 50°, with respect to the central axis X). The outer circumferential recess 142a may be shaped (e.g., tapered axially and radially inward) to provide clearance for the enlarged end portion 146a of the ferrule projection 145a. The final diameter of the folded projection may be selected to match or exceed the diameter of the ferrule boss 125a to reduce or eliminate the contact between the ferrule boss and the retaining component recess outboard radial wall 156a and tapered interior wall 157a with further nut advancement in order to minimize assembly torque. It may be further preferable to define the length of the recess 142a to provide minimal clearance for the inward bending of projection 145a such to support the projection in reaction to axial tensile and compressive loads which may result during potential contact with the interior tapered wall 157a of the nut during further inward axial movement resulting from further pull-up of the nut.

The enlarged load bearing end portion 146a may be asymmetrical about a central axis, with an enlarged outboard side and a flattened inboard side. The enlarged outboard side may provide enhanced rigidity, and may focus the radial load between the nut interior surface 157a and the projection 145a at this enlarged region upon pull-up, thereby acting as a relief to radial loading (and the resulting stresses) at the narrower hinge portions. The flattened inboard side of the end portion may be shaped to more closely correspond with the surface of the outer circumferential recess 142a when the projection is received in the recess during pull-up. While many different end portion shapes may be provided, in the illustrated embodiments, the inboard and outboard sides of the end portion are substantially parallel frustoconical surfaces. Further, the outer surface of the ferrule boss portion 125a may be tapered radially inward and axially outward to form a reduced diameter at the outboard side, such that when the rear end of the front ferrule 124a is expanded during fitting pull-up, the outer surface of the ferrule boss portion 125a more closely corresponds to the interior surface 157a of the nut bore. A relief recess or pocket 147a may be provided between the first hinge portion 191a and the outer circumferential recess 142a, to minimize creasing (and the resulting stresses) at the first hinge portion upon pull-up.

As discussed above, the release condition of the front ferrule from the nut may be selected to coincide with a certain assembly or pull-up condition, for example, a partial pull-up condition (e.g., pull-up sufficient to cause the ferrules to begin plastically deforming the conduit, such that subsequent loosening or separation of the nut from the body permits the released ferrules to maintain gripping engagement with the deformed conduit surfaces), a complete initial pull-up condition, or a subsequent remake condition. To provide this release condition at a desired pull-up condition, one or more of the nut and ferrule interengaging features may be specifically sized, shaped, contoured or otherwise configured to affect the timing and rate of bending of the projection from a cartridged orientation (e.g., from an angle between about 90° and about 50° with respect to the central axis X) to a release orientation (e.g., to an angle between about 35° and about 15° with respect to the central axis X). As one example, since the bending of the front ferrule projection by engagement with the interior nut surfaces relies on relative axial movement of the nut with respect to the front ferrule during pull-up (i.e., during controlled axial movement of the nut relative to the fitting body), according to an aspect of the present application, one or more of the nut and ferrule interengaging surfaces may be configured to increase relative axial movement of the nut with respect to the front ferrule during initial fitting pull-up, by delaying or retarding axial advancement of the front ferrule to accelerate bending of the front ferrule projection during pull-up, thereby increasing initial relative axial movement of the nut with respect to the front ferrule. Several fitting conditions can contribute to, or affect the magnitude of, relative axial movement of the fitting nut with respect to the front ferrule, including, for example, amount of pull-up, tube wall thickness, tube material, an un-bottomed or partially bottomed tube end installed in the fitting. One or more of these conditions may be taken into consideration when selecting, designing, or dimensioning the nut and ferrule interengaging surfaces for increased relative axial movement of the nut with respect to the front ferrule during initial fitting pull-up.

While many different fitting surface arrangements may provide for this delayed axial advancement of the front ferrule during pull-up, as one example, the engaging camming surfaces of the front and rear ferrule may be contoured to increase initial relative axial movement of the rear ferrule with respect to the front ferrule, thereby increasing the initial relative axial movement of the nut with respect to the front ferrule. In the exemplary embodiments of FIGS. 1-3, the front ferrule 124a may be provided with a rear camming mouth 126a having a shallower outer tapered portion 181a that is engaged by the front end portion 128a of the rear ferrule 130a initially (e.g. when the fitting assembly is in a finger tight condition) and during a first duration or portion of pull-up, allowing the rear ferrule front end 128a (and the nut drive surface 134a) surface to axially advance more rapidly with respect to the front ferrule 124a, thus limiting the axial advancement of the front ferrule. In an exemplary embodiment, the outer tapered portion 181a may extend at an angle with respect to the central axis X between about 15° and about 45°, or between about 25° and about 40°, or between about 30° and about 35°. A steeper (i.e., with respect to the outer tapered portion 181a) inner tapered portion 182a of the rear camming mouth 126a engages the front end portion 128a of the rear ferrule 130a during a second duration or portion of pull-up to facilitate radial indentation (and tube grip) of the rear ferrule front end 128a, as well as accelerated axial advancement of the front ferrule 124a with respect to the fitting body 112a for radial indentation of the front camming surface 122a of the front ferrule caused by engagement with the body camming surface. In an exemplary embodiment, the inner tapered portion 182a may extend at an angle with respect to the central axis X between about 35° and about 55°, or between about 40° and about 50°, or about 45°.

A cartridging ferrule may be provided with a wide range of suitable dual camming taper combinations to provide for accelerated initial disengagement or de-cartridging of the ferrule from the nut and for sufficient radial compression of the ferrule(s) onto the installed conduit. In one such embodiment, the shallower outer tapered portion 181a is limited to ensure that sufficient radial compression of the ferrules occurs upon engagement of the front end portion 128a of the rear ferrule 130a with the inner tapered portion 182a of the front ferrule camming mouth 126a. In an exemplary embodiment, the ratio of the radial dimension of the inner tapered portion 182a of the camming mouth 126a to the full radial dimension of the camming mouth may be between about 0.4 and about 0.9, or between about 0.4 and about 0.6. The dual taper surfaces 181a, 182a may be configured to synchronize disengagement or de-cartridging of the ferrule projection 145a from the nut recess 155a with a desired pull-up condition. In one embodiment, the desired pull-up condition is a partial pull-up that is sufficient to cause the ferrules 124a, 130a to begin plastically deforming the conduit 118a, such that subsequent loosening or separation of the nut 114a from the body 112a permits the released ferrules 124a, 130a to maintain gripping engagement with the deformed conduit surfaces. This release may occur before or after the rear ferrule front end 128a engages the inner tapered portion 182a. In some embodiments (not shown) a front ferrule may be provided with a camming mouth having more than two different tapered portions.

According to another aspect of the present application, a delayed axial advancement of the front ferrule during pull-up may additionally or alternatively be achieved by providing the body-engaging front camming surface 122a of the front ferrule 124a with a surface finish adapted for increased friction between the front camming surface 122a and the body camming portion 120a (FIG. 3A), thereby reducing initial axial advance of the front ferrule during pull-up. This reduced initial axial advance may provide for increased relative axial movement of the nut 114a with respect to the front ferrule during pull-up, thereby accelerating the bending movement of the front ferrule cartridging flange 145a for release of the ferrules 124a, 130a from the nut, as described in greater detail above. The reduced initial axial advance of the front ferrule may also provide for accelerated or increased initial compression of the rear ferrule 130a, as the advancing nut drives the rear ferrule further into interengagement with the camming surface(s) 181a, 182a of the front ferrule. Any suitable method for increasing friction may be utilized, including, for example, knurling, laser etching, plating (or removal of plating), and coating (or removal of coating).

Fittings utilizing the cartridging features described herein may be adapted for use with a variety of types and sizes of conduits. For example, the exemplary fitting components of FIGS. 1-3 may be sized or otherwise adapted for use with tubing of any of a variety of diameters, including, for example, ¼ inch, ⅜ inch, ½ inch, 6 mm, 10 mm, and 12 mm, as well as any other tube sizes smaller than, larger than, or in between these sizes. While adaptation of the fitting components for use with a desired conduit size may involve only directly proportional changes in component sizes, in other embodiments, other features may be changed, added, or eliminated to facilitate a desired performance of the fitting, which may or may not be dependent upon the size of the fitting. In one exemplary embodiment, the fitting components of FIGS. 1-3 may be adapted for use with ⅜ inch tube.

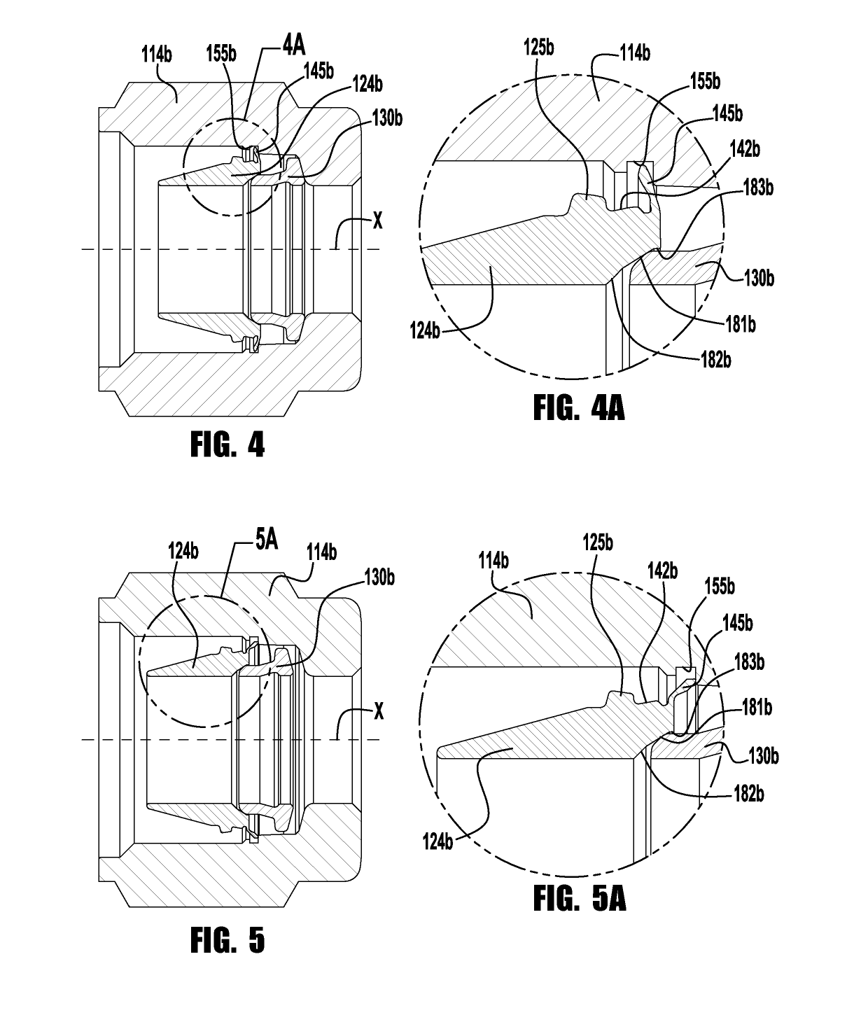

The embodiment of FIGS. 4-6 may be similar to the embodiment of FIGS. 1-3, but with the front ferrule 124b including a small lip or ledge 183b extending axially outward from the outboard end of the outer tapered surface 181b, for example, to radially position the projection 145b with respect to the nose end of the back ferrule 130b, or to axially position the rear end projection 145b with respect to the camming surfaces of the front ferrule 124b. In one such exemplary embodiment, the fitting components of FIGS. 4-6 may be adapted for use with 6 mm tube.

The embodiments of FIGS. 7-9 and 10-12 may be similar to the embodiments of FIGS. 1-3 and 4-6, respectively, but with a single, uniform frustoconical camming surface 181c-d on the front ferrule 124c-d (instead of the dual camming surfaces 181a-b, 182a-b of the embodiments of FIGS. 1-3 and 4-6), for example, to simplify ferrule manufacturing in embodiments for which delayed axial advancement of the front ferrule during pull-up is not required, or in which other fitting features provide for this delayed axial advance (e.g., a front ferrule nose with an increased friction surface finish, as described above). In one such exemplary embodiment, the fitting components of FIGS. 7-9 and 10-12 may be adapted for use with ⅜ inch tube, and ½ inch tube, respectively.

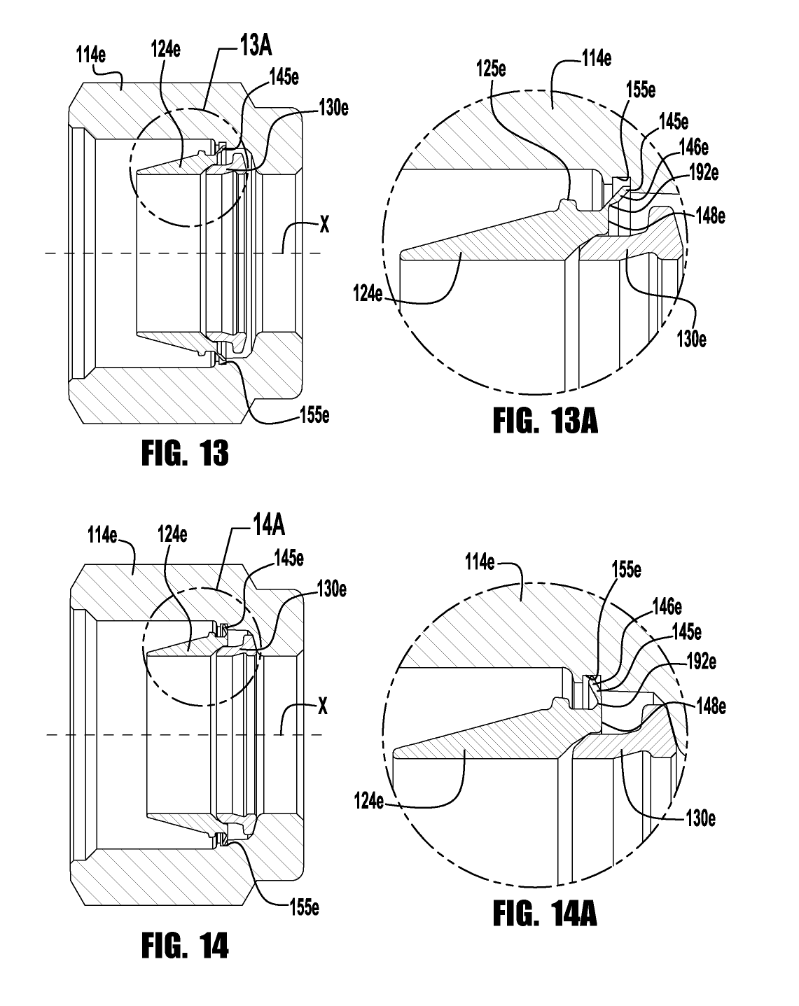

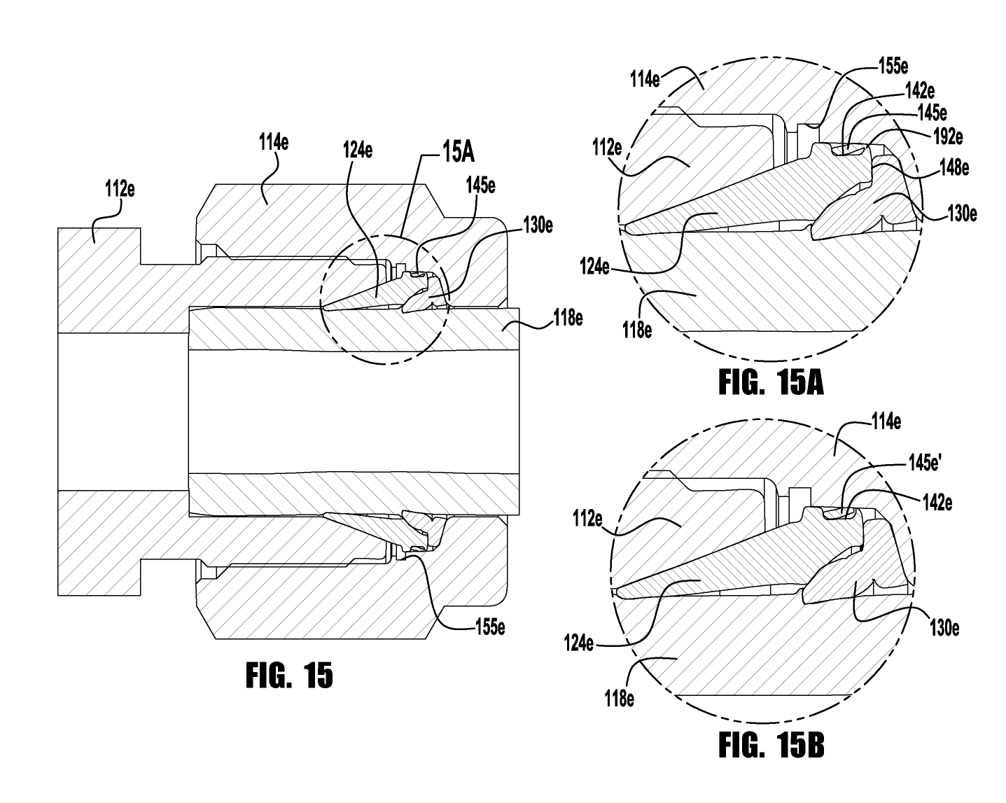

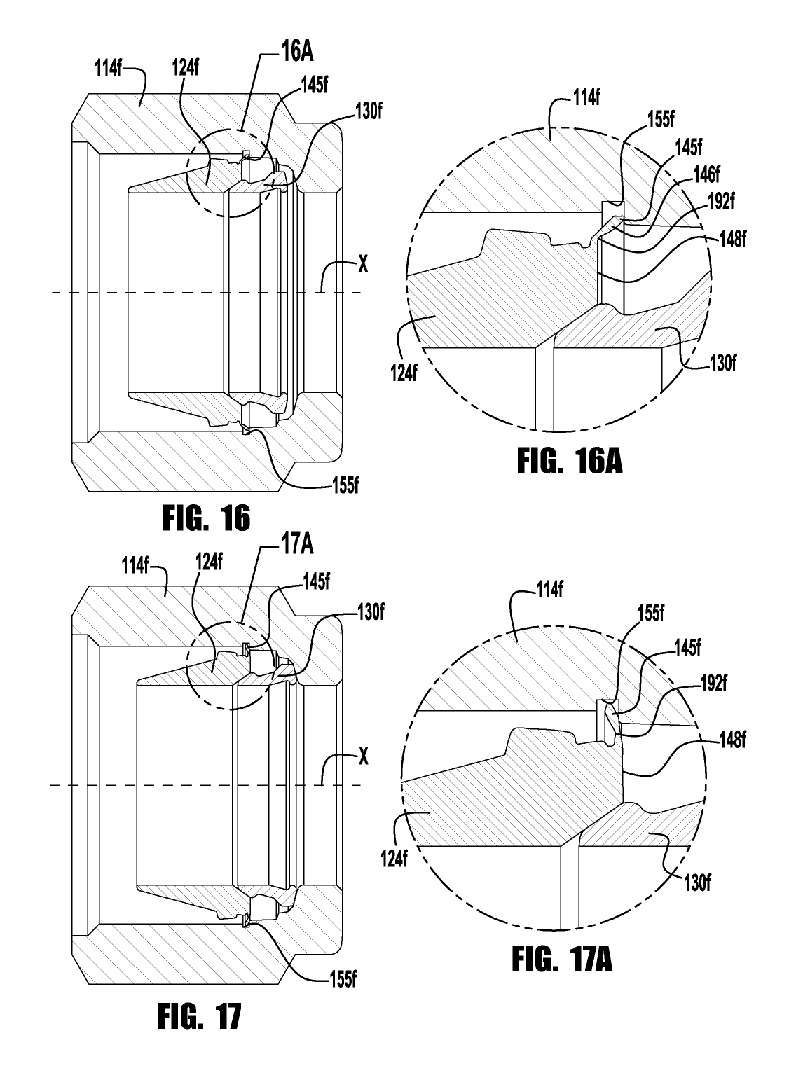

The embodiments of FIGS. 13-15 and 16-18 may be similar to the single camming taper embodiments of FIGS. 4-6 and 7-9, respectively, but with a front ferrule 124e-f having a projection 145e-f with a single hinge 192e-f (instead of the dual hinged projections 145b-c of the embodiments of FIGS. 4-6 and 7-9) defined by an outboard radius portion extending between an outboard radial surface 148e-f of the ferrule 124e-f and an enlarged outboard surface of the end portion 146e-f, for example, to provide for accelerated bending of the flange (and resulting release of the ferrules from the nut) during fitting pull-up. In some embodiments, the accelerated bending of the single hinge projection may adequately replace the accelerated bending achieved by the dual taper camming surfaces, as described above. In one such exemplary embodiment, the fitting components of FIGS. 13-15 may be adapted for use with 10 mm tube, and the fitting components of FIGS. 16-18 may be adapted for use with ½ inch tube.

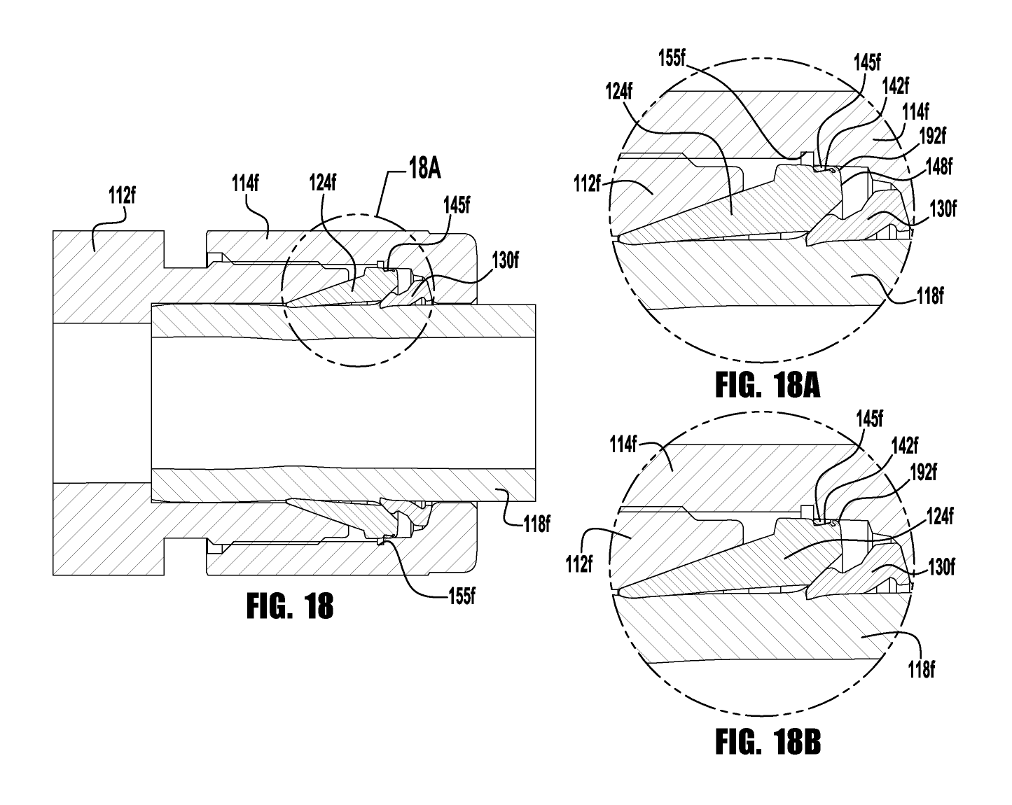

In some embodiments, the single hinge cartridging projection 145e-f may be configured to cause the projection to fracture or separate from the ferrule 124e-f at the single hinge 192e-f during fitting pull-up. As shown in FIGS. 15B and 18B, the separated projections 145e′-f′ may be retained with the ferrule 124e-f in the recess 147e-f between the outer boss 125e-f′ and the non-separated base of the hinge portion, for example, to prevent the separated projection from being loose in the fitting or other portions of the fluid system. Further, the separated condition of the projection 145e′-f′ upon full or partial pull-up may reduce outward radial force and/or friction applied by the projection on the nut bore, thereby reducing installation or remake torque.

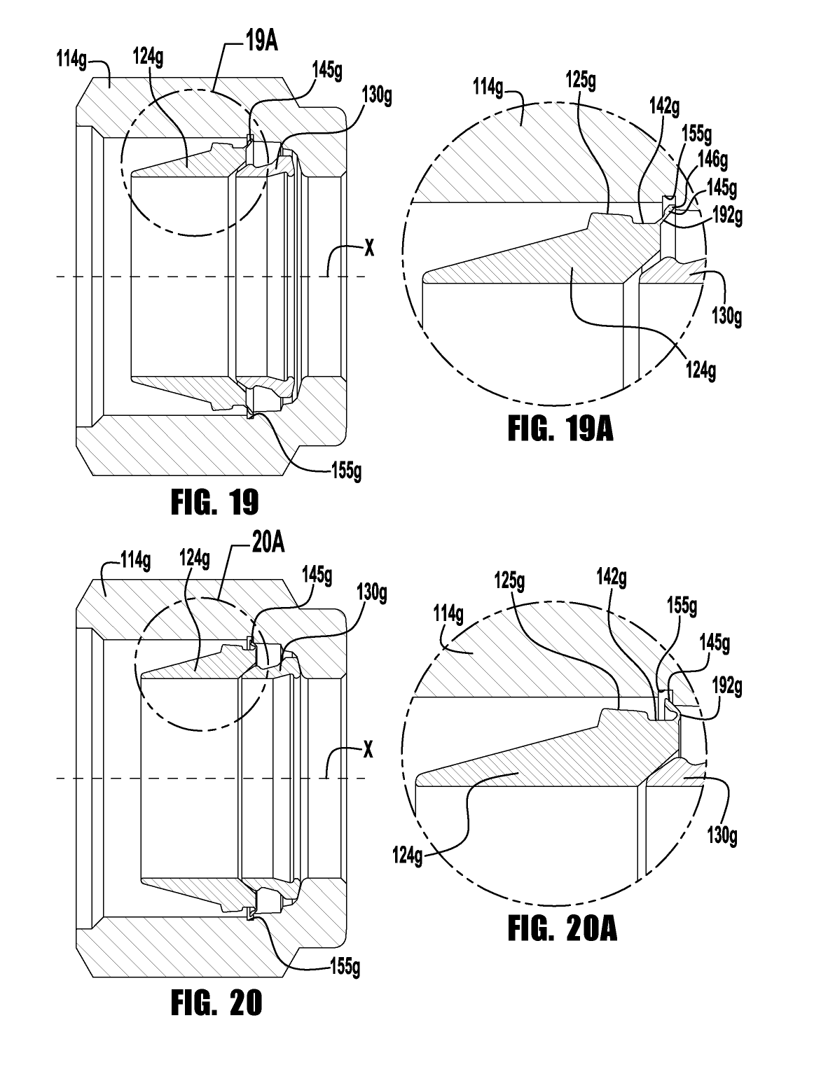

The embodiment of FIGS. 19-21 may be similar to the single camming taper, single hinge embodiment of FIGS. 16-18, but with a front ferrule 124g having a projection 145g with a single hinge 192g defined by an inboard radius portion extending between a circumferential recess 142g of the ferrule 124g and an enlarged inboard surface of the end portion 146g. This hinge arrangement provides for a larger bending radius, which may be employed to prevent separation or fracture of the cartridging projection 145g from the ferrule 124g during pull-up, and/or to delay or retard bending disengagement of the projection 145g from the nut recess 155g. In one such exemplary embodiment, the fitting components of FIGS. 19-21 may be adapted for use with ½ inch tube. In some embodiments (not shown), a ferrule with a forward radiused, single hinged projection may be additionally provided with a dual taper camming surface, as described above, such that the accelerated bending effect of the dual tapered camming surface may compensate for the delayed bending of the forward radiused, single hinged projection.

According to another aspect of the present application, a conduit gripping device may be provided with a cartridging projection that initially (i.e., prior to cartridging) extends in an outboard or axially outward angled orientation such that the projection is loosely received in axial alignment with a retaining recess in a retaining fitting component (e.g., fitting nut), without elastic deformation and snap-in engagement of the projection with the recess.

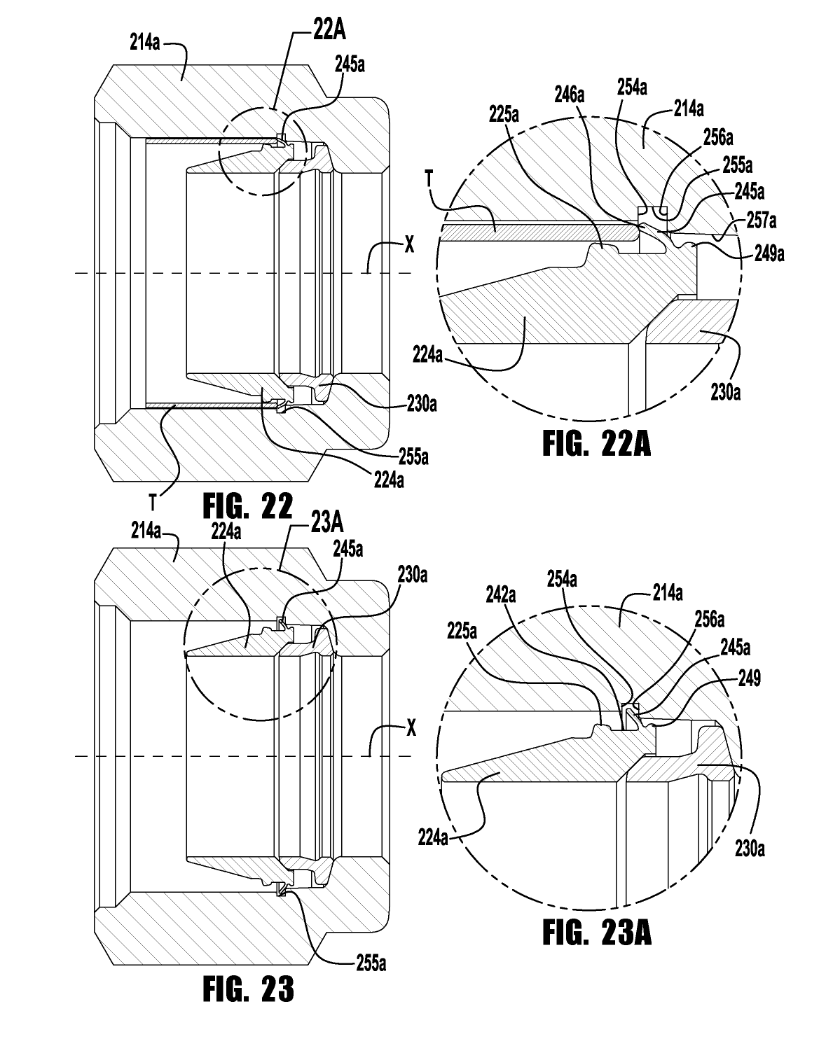

FIGS. 22-24 illustrate an exemplary conduit gripping device (ferrule 224a) with a retaining projection 245a that, prior to cartridging, extends in an axially forward or inward orientation such that the projection is loosely received in axial alignment with a retaining recess 255a in a retaining fitting component (fitting nut 214a). To cartridge the conduit gripping device with the retaining fitting component, as shown in FIGS. 22 and 22A, a tool T is inserted into the nut 214a to engage the projection end portion 246a and bend the projection 245a axially outward and radially outward to a position in which the projection end portion radially aligns with an inboard radial wall 254a defining an inner end of the recess 255a, such that the outward bent projection is axially captured in the recess between the inboard radial wall and the outboard radial wall 256a.

FIGS. 23 and 23A show the nut 214a and ferrules 224a, 230a in a cartridged condition, as a result of the inboard axial load applied to the projection 245a by the tool T, with the projection end portion 246a to extend radially into the nut recess between the inboard and outboard radial walls 254a, 256a, thereby axially retaining the front ferrule 224a (and with it, the captured rear ferrule 230a) with the nut 214a. As shown, the projection 245a may be bent to an axially inward direction (e.g., to an angle between about 90° and about 50° with respect to the central axis X).

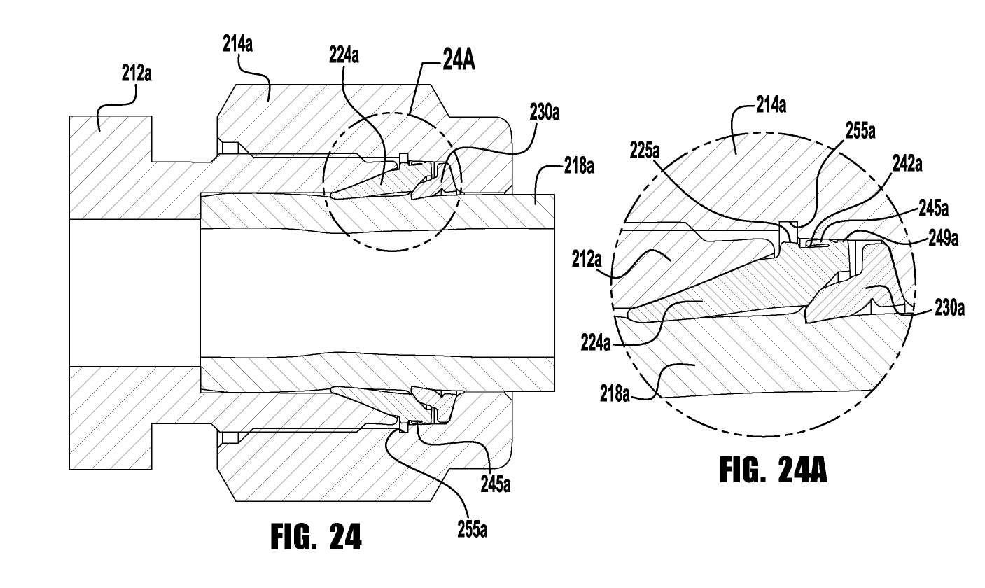

Similar to the embodiments of FIGS. 1-21 described above, the outboard radial wall and outboard surface of the nut interior wall may be configured to bend or pivot the projection axially and radially inward from the laterally outward cartridged condition during complete or partial pull-up of the fitting on a conduit end, such that the end portion of the projection is positioned radially inward of the inboard surface of the nut interior wall, to allow withdrawal of the ferrules from the nut when the nut is disassembled from the body. FIGS. 24 and 24A show the nut 214a and ferrules 224a, 230a pulled up with a fitting body 212a on a conduit end 218a, with the front ferrule projection 245a bent into a fully axially inboard direction (e.g., to an angle between about 10° and about −10°, or about −5°, with respect to the central axis X), such that the projection is fully disengaged from the nut recess 255a and received in the outer circumferential recess 242a in the front ferrule 224a, and above, flush with, or even recessed from the outer surface of the ferrule boss 225a. The outer circumferential recess 242a may be shaped (e.g., tapered axially and radially inward) to provide clearance for the enlarged end portion 246a of the ferrule projection 245a. It may be further preferable to define the length of the recess 242a to provide minimal clearance for the inward bending of projection 245a such to support the projection in reaction to axial tensile and compressive loads which may result during potential contact with the interior tapered wall 257a of the nut during further inward axial movement resulting from further pull-up of the nut. Additionally or alternatively, the ferrule 224a may be provided with a rear raised portion 249a, behind the projection 245a, that engages the tapered interior wall 157a of the nut to reduce radial load on the bent projection 245a.

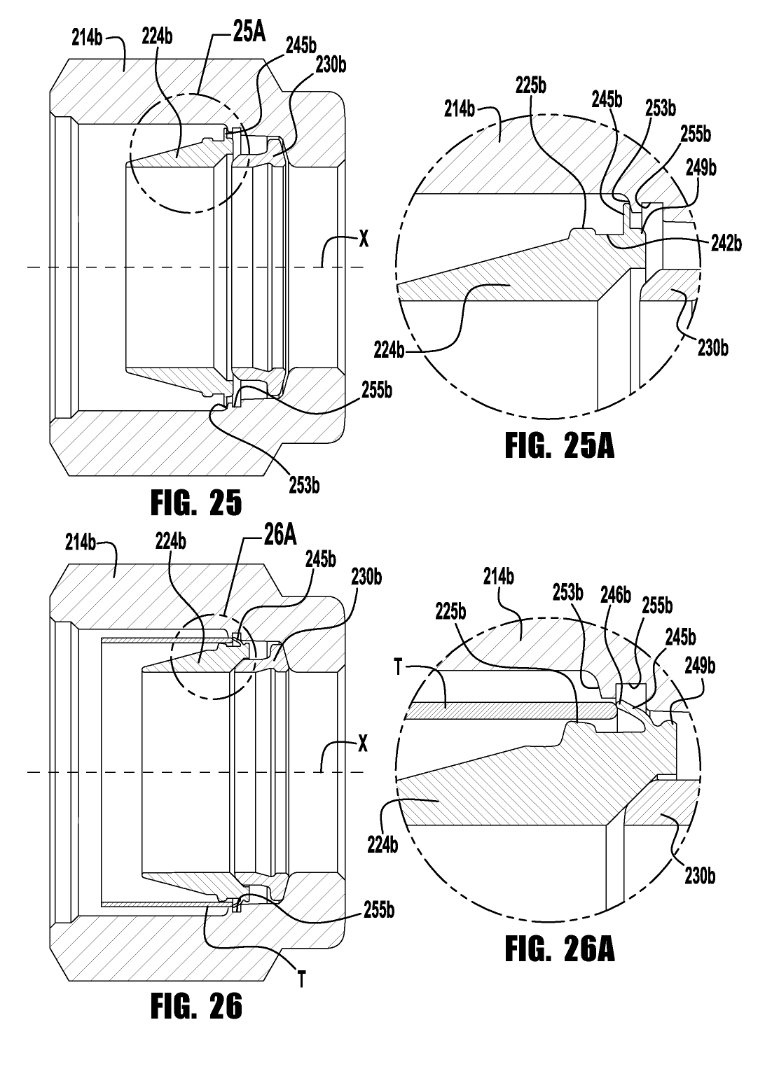

While the ferrule 224a of FIGS. 22-24 may be machined with an axially forward or inward angled projection 245a, in other embodiments, the ferrule may be machined with a radially outward extending projection, or even an axially rearward or outward angled projection, with the projection being subsequently crimped or staked radially and axially inward to the desired axially forward or inward angled orientation. FIG. 25 illustrates an exemplary ferrule 224b having a radially outward extending projection 245b. While this ferrule projection 245b may be staked radially and axially inward in a pre-assembly operation on the ferrule 224b, in the illustrated embodiment, the ferrule projection 245b is bent during insertion of the ferrule 224b into the nut 214b, by axially forcing the projection end portion 246b against a tapered or stepped internal surface 253b of the nut 214b. Once the projection 245b is axially forced past the stepped surface 253b into axial alignment with the recess 255b (FIGS. 26 and 26A), the projection may be bent axially and radially outward by insertion of the tool T into the nut 214b and against the projection end portion 246b, similar to the embodiment of FIGS. 22-24. In some embodiments, the bent projection, after passing the stepped surface 253b, is fully disengaged or radially spaced apart from the nut recess 255b, with the inserted tool T expanding the disengaged projection into engagement with the nut recess. In other embodiments, the bent projection 245b, after passing the stepped surface 253b, may elastically expand or “snap” radially outward, for example, into partial engagement, light engagement, or near engagement with the nut recess 255b. In such an embodiment, radial expansion of the projection 245b using the tool T can provide more consistent or secure retention of the projection in the nut recess.

In other embodiments, other features of the fitting components of FIGS. 1-21 may additionally or alternatively be incorporated into the fitting components of the embodiments of FIGS. 22-28, including, for example, forming the projection with one or more hinge portions, forming the projection with an enlarged end portion contour, forming the front ferrule camming surface with multiple tapered portions, and/or adapting the projection to be fractured or separated upon bending during pull-up (and retained in the recess between the ferrule boss 225a-b and the rear raised portion 249a-b).

As discussed above, a retaining projection of a ferrule may be contoured to provide one or more hinge portions to facilitate or control bending during fitting pull-up. In other exemplary embodiments, all or part of the ferrule projection may be induction heated, laser annealed, or otherwise treated to provide a material property different from that of the ferrule body, such as, for example, greater ductility, lower material yield strength, or higher percent elongation of all or part of the ferrule projection. In still other exemplary embodiments, all or part of the ferrule projection may additionally or alternatively be perforated, segmented (e.g., slit or stamped) or otherwise non-continuous to facilitate plastic deformation of the projection during cartridging and/or pull-up. Such operations may be utilized in place of the projection hinge and end portion contours described above, for example, to facilitate manufacturing, or in addition to the projection contouring, to further enhance bending performance.

In some embodiments, in accordance with another aspect of the present application, a cartridging ferrule may be provided with a separate flange ring that is secured to a rear portion of the ferrule to provide a cartridging projection. By producing the projection as a separate component, the projection may be more easily produced with different mechanical material properties (e.g., ductility, elasticity) than the sealing and camming portions of the ferrule, for which other mechanical properties may be more desirable. Additionally or alternatively, the projection may be more easily constructed, as compared to integral machining with the ferrule, to have different structural features, such as, for example, hinging and/or end portion contours, angled orientations, or bend facilitating perforations or segments, or to reduce the barstock size from which the ferrule is manufactured.

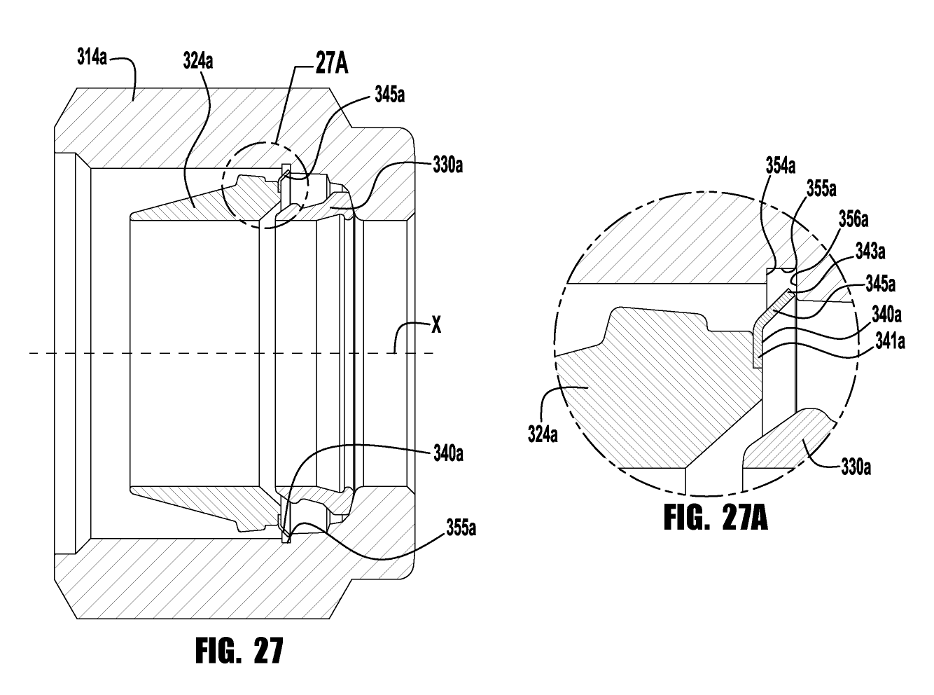

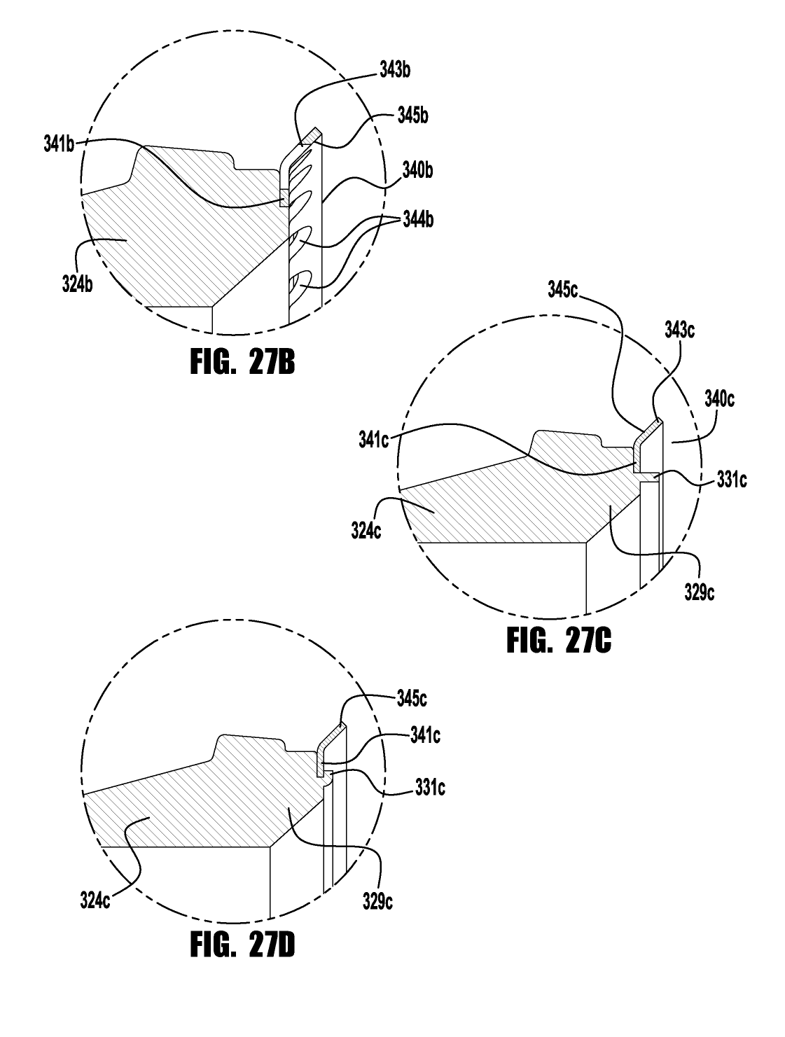

FIGS. 27 and 27A illustrate an exemplary conduit gripping device (ferrule 324a) with an attached flange ring 340a defining a retaining projection 345a that initially (i.e., prior to cartridging) extends in a radially outward orientation such that the projection is loosely received in axial alignment with a retaining recess 355a in a retaining fitting component (fitting nut 314a). An inner radial portion 341a of the ring 340a is affixed to a rear portion 329a of the ferrule 324a, for example, by welding (e.g., spot welding), brazing, adhesive, or press fit retention. An outer radial flanged portion extends from the inner radial portion 341a to define the projection 345a. To cartridge the ferrules 324a, 330a with the nut 314a, the retaining fitting component includes an inward facing, outboard radial wall 356a that defines an outer end of the recess 355a and extends radially inward into alignment with the end portion 346a of the projection. When an axial outward force is applied to the ferrule 324a to engage the projection end portion 346a with the outboard radial wall 356a, the projection 345a is bent or pivoted axially forward and radially outward to a position in which the projection end portion radially aligns with an inboard radial wall 354a defining an inner end of the recess 355a, such that the outward bent projection is axially captured in the recess between the inboard radial wall and the outboard radial wall, consistent with the embodiments of FIGS. 1-21 described above.

While the flange ring 340a of FIGS. 27 and 27A is shown as having a bent outer flange portion 343a defining a projection 345a having a substantially uniform thickness, in other embodiments, the outer flange portion may be provided with other contours, such as the hinge and end portion contours of any of the integral flange ferrule embodiments described herein, or any of the ferrule projection embodiments of the above incorporated '810 Patent, '288 Application, '048 Application, and '694 Application. In still other embodiments, the projection-defining flange portion may include one or more perforations, slots, notches or other such features, for example, to facilitate bending of the projection during pull-up. FIG. 27B illustrates an exemplary conduit gripping device (ferrule 324b) with an attached flange ring 340b defining a retaining projection 345b that includes a ring of perforations 344b sized and positioned to facilitate bending of the projection during fitting pull-up.

In other embodiments, a rear portion of a ferrule may be crimped or staked to secure a cartridging flange ring to the ferrule. FIG. 27C illustrates an exemplary conduit gripping device (ferrule 324c) having a rear portion 329c with a rearward or axially outward extending annular tab 331c that is staked, crimped, or peened radially outward to secure the flange ring 340c to the rear end portion 329c of the ferrule 324c, as shown in FIG. 27D.

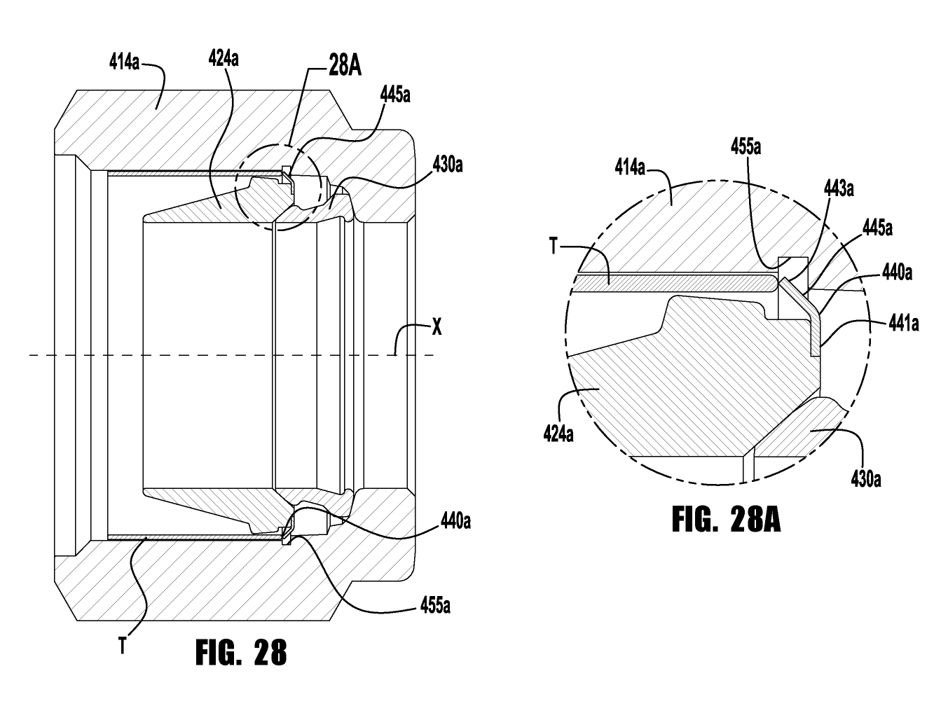

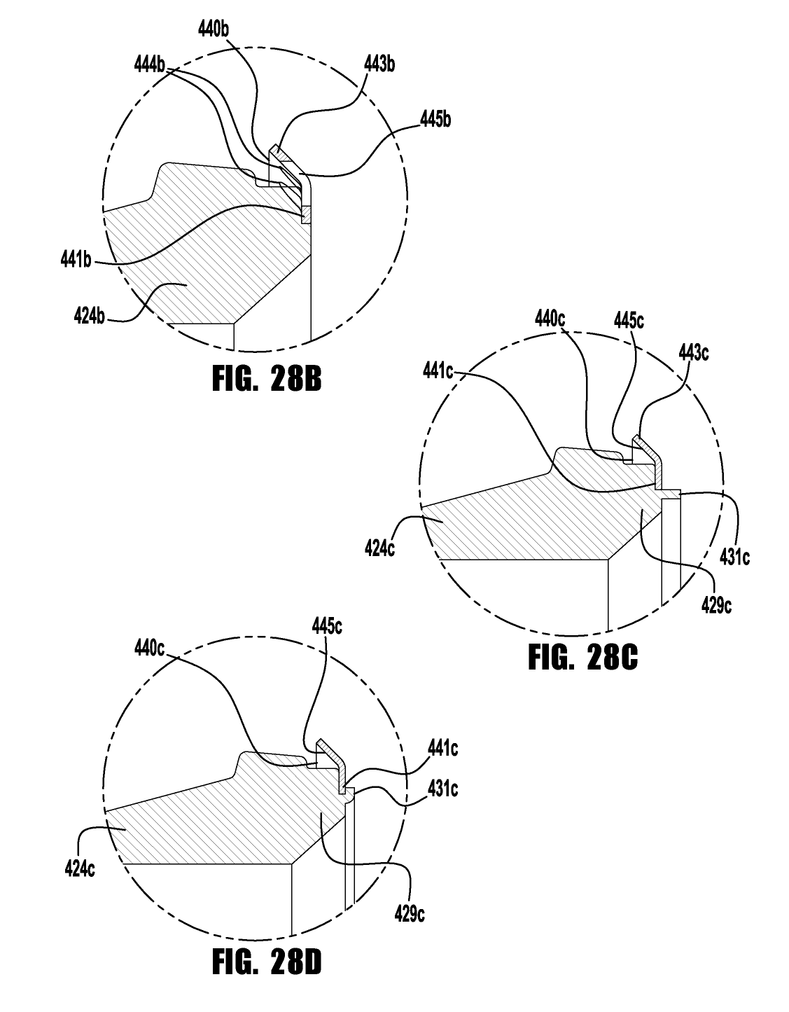

FIGS. 28 and 28A illustrate an exemplary conduit gripping device (ferrule 424a) with an attached flange ring 440a defining a retaining projection 445a that initially (i.e., prior to cartridging) extends in a radially inward orientation such that the projection is loosely received in axial alignment with a retaining recess 455a in a retaining fitting component (fitting nut 414a). An inner radial portion 441a of the ring 440a is affixed to a rear portion 429a of the ferrule 424a, for example, by welding (e.g., spot welding), brazing, adhesive, or press fit retention. To cartridge the ferrules 424a, 430a with the nut 414a, a tool T is inserted into the nut 414a to engage the projection end portion 446a and bend the projection 445a axially outward and radially outward to a position in which the projection end portion radially aligns with an inboard radial wall 454a defining an inner end of the recess 455a, such that the outward bent projection is axially captured in the recess between the inboard radial wall and the outboard radial wall 456a.

While the flange rings 440b of FIGS. 28 and 28A is shown as having a bent outer flange portion 443a defining a projection 445a having a substantially uniform thickness, in other embodiments, the outer flange portion may be provided with other contours, such as the hinge and end portion contours of any of the integral flange ferrule embodiments described herein, or any of the ferrule projection embodiments of the above incorporated '810 Patent, '288 Application, '048 Application, and '694 Application. In still other embodiments, the projection-defining flange portion may include one or more perforations, slots, notches or other such features, for example, to facilitate bending of the projection during pull-up. FIG. 28B illustrates an exemplary conduit gripping device (ferrule 424b) with an attached flange ring 440b defining a retaining projection 445b that includes a ring of perforations 444b sized and positioned to facilitate bending of the projection during fitting pull-up.

FIG. 28C illustrates another exemplary conduit gripping device (ferrule 424c) having a rear portion 429c with a rearward or axially outward extending annular tab 431c that is staked, crimped, or peened radially outward to secure the flange ring 440c to the rear end portion 429c of the ferrule 424c, as shown in FIG. 30D.

Other features or conditions of the embodiments of the inventions described herein may facilitate assembly of the cartridged subassembly. As another example, the front and rear ferrules may themselves include features for cartridging together, either prior to or synchronous with assembly with the fitting nut, similar to the cartridging ferrule embodiments described in pending U.S. Patent Application Pub. No. 2010/0148501, filed on Dec. 10, 2009 for FERRULE ASSEMBLY FOR CONDUIT FITTING (the “'501 Application”), and U.S. Patent Application Pub. No. 2015/0323110, filed on May 8, 2015 for CONDUIT FITTING WITH COMPONENTS ADAPTED FOR FACILITATING ASSEMBLY (the “'110 Application”), the entire disclosure of which is incorporated herein by reference, and in the above incorporated '810 Patent and '288 Application.

The inventive aspects have been described with reference to the exemplary embodiments. Modification and alterations will occur to others upon a reading and understanding of this specification. It is intended to include all such modifications and alterations insofar as they come within the scope of the appended claims or the equivalents thereof.

We claim:

1. A preassembly for a conduit fitting, comprising:
an annular fitting component having an interior wall extending along a central axis from an inboard end to an outboard end, the interior wall including an inboard surface having a first diameter, an outboard surface having a second diameter, and an intermediate surface recessed from the inboard surface by an outward facing inboard radial wall and recessed from the outboard surface by an inward facing outboard radial wall; and
at least a first conduit gripping device retained within the annular fitting component and including a body portion and an annular ring portion having an inner radial portion secured to a rear surface of the body portion, and a flange portion extending radially outward of the inner radial portion to define a projection extending radially outward of an outer circumferential surface of the first conduit gripping device, with an end portion of the projection being axially captured between the inboard radial wall and the outboard radial wall.

2. The preassembly of claim 1, wherein the annular ring portion is welded to the rear surface of the body portion.

3. The preassembly of claim 1, wherein the annular ring portion is peened onto the rear surface of the body portion.

4. The preassembly of claim 1, wherein the projection extends axially toward an inboard end of the first conduit gripping device.

5. The preassembly of claim 1, wherein the projection extends at an angle between about 90° and about 130° with respect to the central axis.

6. The preassembly of claim 1, wherein the projection extends around an entire circumference of the outer surface of the first conduit gripping device.

7. The preassembly of claim 1, wherein the projection is plastically deformable about a radially inward hinge portion of the projection.

8. The preassembly of claim 1, wherein the second diameter is smaller than the first diameter.

9. The preassembly of claim 1, wherein when an outward axial force is applied to the first conduit gripping device to force the end portion of the projection against the outboard radial wall, the projection is bent axially inward to position the end portion of the projection at a third diameter smaller than the first diameter, to permit removal of the first conduit gripping device from the annular fitting component.

10. The preassembly of claim 1, wherein the flange portion comprises at least one of perforations, slots, notches, or other discontinuities selected to facilitate axially inward bending of the projection.

11. The preassembly of claim 1, wherein the body portion of the first conduit gripping device comprises a first material, and the annular ring portion comprises a second material different from the first material.

12. The preassembly of claim 11, wherein the second material has a ductility greater than a ductility of the first material.

13. The preassembly of claim 11, wherein the second material is annealed.

14. The preassembly of claim 1, further comprising a second conduit gripping device axially captured between the first conduit gripping device and an annular shoulder at the outboard end of the annular fitting component.

15. The preassembly of claim 1, wherein the outboard radial wall extends at an angle between about 90° and about 135° with respect to the central axis.

16. The preassembly of claim 1, wherein the outboard radial wall extends substantially perpendicular to the central axis.

17. The preassembly of claim 1, wherein the projection comprises a circumferential skirt having an inboard wall surface and an outboard wall surface together defining a thickness of the skirt.

18. The preassembly of claim 1, wherein the inboard wall surface and the outboard wall surface are substantially parallel.

19. A method of assembling an annular fitting component with at least a first conduit gripping device, the method comprising:
inserting the first conduit gripping device into an inboard end of the annular fitting component, such that a projection extending axially forward toward a front end of the first conduit gripping device and radially outward of an outer circumferential surface of the first conduit gripping device to a first diameter is received through an inboard surface of an interior wall of the annular fitting component along a central axis, and axially aligns with an annular recess of the interior wall; and
inserting a tool into the inboard end of the annular fitting component to apply an outward axial force against the projection, such that the projection is bent axially and radially outward to position an end portion of the projection within the annular recess, to axially capture the projection between the inboard radial wall and the outboard radial wall.

20. A fitting assembly comprising:
an annular first fitting component having an interior wall defining an annular recess disposed between an outward facing inboard radial wall and an inward facing outboard radial wall; and
an annular second fitting component assembled with the first fitting component to define an interior volume surrounded by the interior wall of the first fitting component; and
at least a first conduit gripping device retained within the first fitting component and including a projection extending radially outward from a hinge portion disposed on an outer surface of the first conduit gripping device, to an end portion axially captured in the annular recess;
wherein when the fitting is pulled up on a conduit end, the end portion of the projection engages the outboard radial wall and the projection bends axially and radially inward and the projection separates from the first conduit gripping device at the hinge portion, the separated projection being received in an outer circumferential recess of the first conduit gripping device, such that the separated projection is retained with the first conduit gripping device, and the first conduit gripping device is removable from the first fitting component when the first fitting component is disassembled from the second fitting component.
